(19) United States
(12) Patent Application Publication
(10) Pub. No.: US 2026/0251437 A1
(43) Pub. Date: Aug. 27, 2026

(54) PLANAR COIL ARRAY AND DISPLACEMENT SENSOR

(71) Applicant: Hitachi Astemo, Ltd., Hitachinaka-shi (JP)

(72) Inventors: Yosuke MURAKAMI, Hitachinaka-shi (JP); Yosuke FUJIKAWA, Hitachinaka-shi (JP)

(73) Assignee: Hitachi Astemo, Ltd., Hitachinaka-shi (JP)

(21) Appl. No.: 18/992,171

(22) PCT Filed: Jul. 11, 2022
(86) PCT No.: PCT/JP2022/027313

§ 371 Date: Jan. 7, 2025

(51) Int. Cl. G01B 7/02; H01F 27/28

(52) U.S. Cl. CPC G01B 7/023; H01F 27/2804; H01F 27/2871; H01F 2027/2809

(57) ABSTRACT

A planar coil array has a simplified structure and can be used as an electric signal path. The planar coil array comprises: a first planar coil that has a first spiral shape in which a first conductor is wound in a left-handed or right-handed manner with respect to a first center; a second planar coil that has a second spiral shape in which a second conductor in the same layer as the first conductor is wound with respect to a second center in the same winding manner as the first planar coil, the second spiral shape having an angular misalignment from the first spiral shape; and a first connection conductor that electrically connects the first and second planar coils. When a current flows from the center toward a terminal part of the first planar coil, a current flows from a terminal part toward the center of the second planar coil.

### CROSS-REFERENCE TO RELATED PATENT APPLICATIONS

This application is a U.S. National Phase Application under 35 U.S.C. § 371 of International Patent Application No. PCT/JP2022/027313 filed on Jul. 11, 2022, the content of which is incorporated herein by reference in its entirety. The International Application was published in Japanese on Jan. 18, 2024 as International Publication No. WO/2024/013824 under PCT Article 21(2).

### FIELD OF THE INVENTION

The present invention relates to a planar coil array, a displacement sensor, or the like.

### BACKGROUND OF THE INVENTION

FIG. 1 of WO2020/035968 shows a planar coil array including a plurality of coils, and FIG. 5 shows a current flow in each planar coil.

In paragraph [0027] of this Literature, “currents having opposite turning directions flow in the two coil portions L1a and L1b of the coil L1” is described. In other words, the two adjacent coil portions have opposite spiral winding directions.

As is clear from FIG. 5, when a current flows from a terminal on an outer circumferential side of a spiral to a center of the spiral in one coil, a current also flows in the same direction in the other coil. In other words, the current flows in the same direction.

JP6450611B describes a stroke sensor applicable to a vehicle such as a motorcycle.

FIGS. 9 and 10 of JP6450611B show a stroke sensor that detects a change in a frequency of an alternating-current (AC) signal flowing through a coil in accordance with a change in a length of an overlap between a movable conductor and the coil, that is, a change in a fitting length, and detects a stroke amount.

### CITATION LIST

### Patent Literature

Patent Literature 1: WO2020/035968

Patent Literature 2: JP6450611B

### Technical Problem

The present inventors have found the following problems. That is, in WO2020/035968, a wiring configuration connecting each planar coil is complicated, and the planar coil array is inevitably increased in size.

Further, in WO2020/035968, a plurality of coils can be combined to form one coil having a large number of turns. However, an electric signal cannot be transmitted via each coil. In other words, since a path of the electric signal cannot be formed, it is difficult to apply the planar coil array to an application for detecting electrical characteristics of the electric signal, such as a stroke sensor. Further, the path of the electric signal is required to transmit the electric signal with low loss. WO2020/035968 does not refer to this point.

Further, the creation of the coil fitted to the cylindrical conductor described in JP6450611B takes time and cost.

An object of the present invention is to provide a planar coil array that is simplified in configuration and is usable as a path of an electric signal.

Another object of the present invention is to provide a displacement sensor capable of reducing the number of steps and reducing a cost during manufacture.

### SUMMARY OF THE INVENTION

### Solution to Problem

As a result of intensive studies, the present inventors have found that the above problem can be solved by adjusting a direction of a current flowing through each planar coil of two planar coils disposed adjacent to each other and devising the shape of each spiral.

The present invention was completed based on these findings.

Hereinafter, the present disclosure will be described.

According to a first aspect of the present disclosure, there is provided a planar coil array (AR) including: a first planar coil (SU1) having a first spiral shape in which a first conductor (310) is wound around a first center (50) in a left-handed manner or a right-handed manner; a second planar coil (SU2) having a second spiral shape in which a second conductor (314) on the same layer as the first conductor is wound around a second center (50) in the same manner as the first coil and has an angular deviation from the first spiral shape, and disposed adjacent to the first planar coil in a predetermined direction; and a first connection conductor (83) configured to electrically connect the first and second planar coils, in which when a current flows from the first center toward a first end portion on a side opposite to the first center in the first planar coil (SU1), a current flows from a second end portion on a side opposite to the second center toward the second center in the second planar coil (SU2), and when a current flows from the first end portion toward the first center in the first planar coil (SU1), a current flows from the second center toward the second end portion in the second planar coil (SU2).

In a preferable example, the angular deviation may be a deviation of 180 degrees.

According to another aspect of the present disclosure, there is provided with a planar coil array including: a plurality of the above planar coil arrays (AR-1 to AR-3), in which the planar coil arrays (AR-1 to AR-3) extend parallel to each other along a predetermined direction and are stacked at intervals in a direction orthogonal to the predetermined direction, and the planar coil arrays are electrically connected to form one planar coil array (AR).

Here, the interval is not limited to the magnitude thereof, and may be an object with an insulator interposed therebetween as long as insulation is ensured.

According to still another aspect of the present disclosure, there is provided a displacement sensor (150) including: the above planar coil array (AR); and a detection unit (7) configured to detect a change in electrical characteristics of an electric signal, which is generated according to a displacement amount of the movable conductive object (M1) and transmitted via the planar coil array.

### Advantageous Effects of Invention

According to the present invention, it is possible to provide the planar coil array that is simplified in configuration in which the plurality of planar coils are electrically connected and is usable as a low-loss path of the electric signal.

According to the present invention, the planar coil array capable of generating a strong magnetic field can be provided.

Further, according to the present invention, the displacement sensor capable of reducing man-hours and cost during manufacture can be provided.

### BRIEF DESCRIPTION OF THE DRAWINGS

FIG. 1 is a diagram showing an overall configuration and an equivalent circuit of a planar coil array according to Embodiment 1.

FIG. 2 is a diagram showing an arrangement of two planar coils disposed adjacent to each other in FIG. 1, directions of flowing currents, and electrical connection.

FIG. 3 is a diagram showing another example of the arrangement of the two planar coils disposed adjacent to each other, the directions of the flowing currents, and the electrical connection.

FIG. 4 is a diagram showing another example of the electrical connection between the two planar coils disposed adjacent to each other in FIG. 2.

FIG. 5 is a diagram showing an example of an arrangement of a planar coil array having a multilayer structure using four planar coils, a current flow, and electrical connection.

FIG. 6A is a diagram showing a configuration in which a movable conductor is disposed near a planar coil array having a multilayer structure using eight planar coils.

FIG. 6B is a cross-sectional view of the planar coil array and the movable conductor in FIG. 6A.

FIG. 7 is a cross-sectional view of a structure in which shield members for shielding a magnetic field are provided between the planar coil array and an object to be protected disposed around the planar coil array.

FIG. 8 is a diagram showing a configuration in which a magnetic shield member functions as a yoke as a component of the magnetic circuit.

FIG. 9 is a diagram showing an example of an undesirable effect due to the planar coil array functioning as a transmission path of an AC signal.

FIG. 10 is a diagram showing an example of a configuration of shield members for suppressing the undesirable effects shown in FIG. 9.

FIG. 11 is a view showing a relative positional relationship between the shield members and a planar coil array shown in FIG. 10.

FIG. 12 is a diagram showing another configuration example of the magnetic shield members.

FIG. 13 is a diagram showing still another configuration example of the magnetic shield members.

FIG. 14 is a diagram showing a configuration using a comb-tooth-shaped movable conductor and a plurality of planar coil arrays.

FIG. 15 is a diagram showing an arrangement example of the magnetic shield members.

FIG. 16 is a diagram showing a structure example of a planar coil array having a three-dimensional shape and a direction of a generated magnetic field.

FIG. 17 is a diagram showing another structure example of the planar coil array having the three-dimensional shape and the direction of the generated magnetic field.

FIG. 18 is a diagram showing a detection principle of a displacement sensor.

FIG. 19A is a diagram showing an example of a specific configuration of the displacement sensor.

FIG. 19B is a diagram showing an example of a change in frequency of a current pulse signal corresponding to a change in a fitting length between the movable conductor and a coil.

FIG. 20 is a diagram showing an example of an overall configuration of a motorcycle in which the displacement sensor of the present invention is applied to a suspension.

FIG. 21 is a cross-sectional view showing an example of a sectional structure of a rear suspension shown in FIG. 20.

FIG. 22 is a diagram showing an example of a planar coil in the related art extending in one direction.

FIG. 23 is a diagram showing a configuration example of a planar coil array in a comparative example.

### DETAILED DESCRIPTION OF THE INVENTION

Embodiments of the present invention will be described below with reference to the accompanying drawings. The embodiments shown in the accompanying drawings are examples of the present invention, and the present invention is not limited to the embodiments.

### Embodiment 1

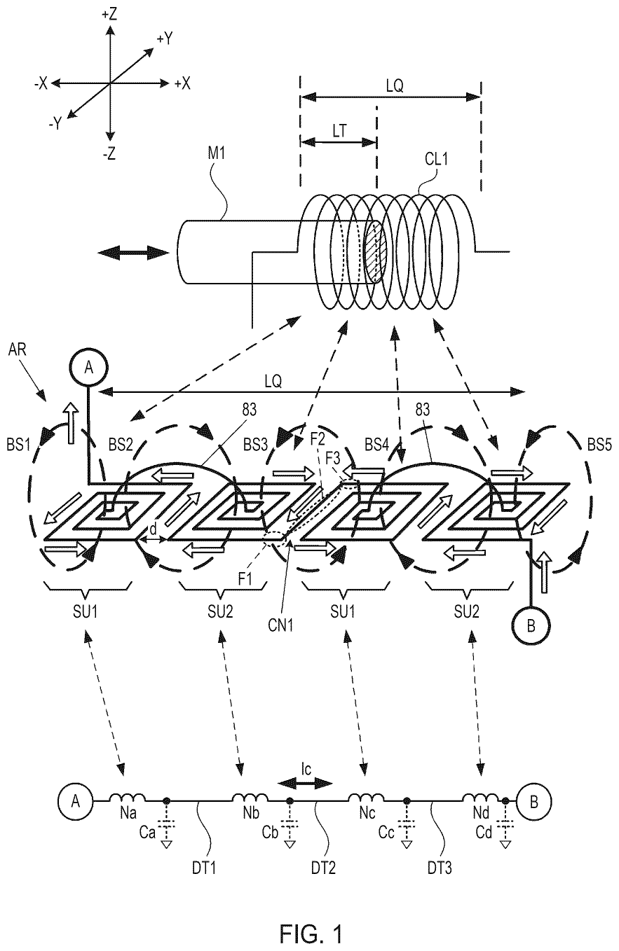

FIG. 1 is referred to. FIG. 1 is a diagram showing an overall configuration and an equivalent circuit of a planar coil array according to Embodiment 1.

In FIG. 1, an X direction may be referred to as a horizontal direction or a left-right direction, a Y direction may be referred to as a width direction, and a Z direction may be referred to as a height direction or an upper-lower direction. A +X direction may be referred to as a right direction, a −X direction may be referred to as a left direction, a +Y direction may be referred to as a positive width direction, a −Y direction may be referred to as a negative width direction, a +Z direction may be referred to as an upper direction, and a −Z direction may be referred to as a lower direction. This point also applies to the subsequent drawings.

In the following description, a term “planar coil” is mainly used, and this term can be replaced by a term “planar coil unit”.

In the following description, a term “right-handed” or “left-handed” may be used in relation to the shape of a spiral. A case where a conductor is wound around a center of the spiral, in other words, a center of the planar coil in a clockwise direction is referred to as the right-handed. A case where the conductor is wound around the center of the spiral, in other words, the center of the planar coil in a counterclockwise direction is referred to as the left-handed.

Further, a direction of a current flowing in the spiral includes a first direction in which a current flows from the center of the spiral to an end portion on an outer circumferential side and a second direction in which a current flows from the end portion on the outer circumferential side to the center of the spiral.

For example, when the current in the first direction flows in a left-handed spiral, a rotation direction of the current is left rotation which is the same as a winding direction of the spiral. On the other hand, when the current in the second direction flows, the rotation direction of the current is right rotation which is opposite to the winding direction of the spiral.

It is necessary to distinguish the spiral winding direction from the rotation direction of the current flowing in the spiral. The rotation direction of the current can be rephrased as a turning direction of the current.

An upper side of FIG. 1 shows a relative positional relationship between a movable conductor and a coil in a stroke sensor as a displacement sensor. The stroke sensor will be described in detail later.

A coil CL1 extends long along the horizontal direction and has a length LQ in the horizontal direction. Here, a movable object M1 is depicted as a cylindrical conductor.

The object M1 is fitted to the coil CL1 with a fitting length LT. When the object M1 is displaced in a direction of a central axis of the cylinder, in other words, in the horizontal direction, the fitting length LT fluctuates, and accordingly, a leakage current fluctuates, and inductance of the coil CL1 changes. Due to the change in the inductance, a resonance frequency of an oscillator (not shown) connected to the coil CL1 changes. For example, a current pulse signal whose frequency changes can be obtained according to a change in the oscillation frequency.

In FIG. 1, the conductor M1 moves for convenience, but the coil CL1 may move. In other words, a relative positional relationship between the conductor M1 and the coil CL1 varies.

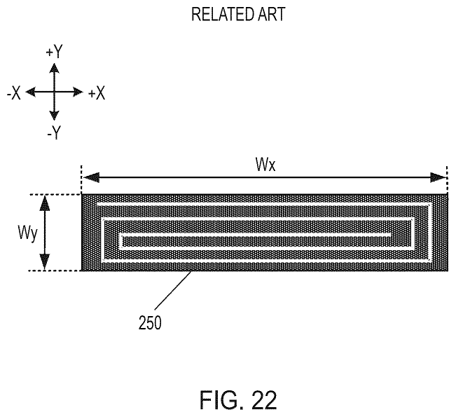

It is difficult to implement the coil CL1 by one planar coil. Here, FIG. 22 is referred to. FIG. 22 is a diagram showing an example of a planar coil in the related art extending in one direction. In a planar coil 250 shown in FIG. 22, a length in a lengthwise direction is Wx and a length in a widthwise direction is Wy. When the number of turns is increased, since the length in the widthwise direction is short, this part limits the number of turns. Accordingly, it is difficult to prepare a coil that generates a strong magnetic field.

Thus, in the present invention, a coil extending along a predetermined direction is implemented by using a planar coil array including a plurality of planar coils.

Referring back to FIG. 1, the description will be continued. As shown in a center of FIG. 1, the coil CL1 can be implemented by, for example, a planar coil array AR implemented by connecting four planar coils in series between power supply terminals A and B.

The planar coil array AR can be implemented by arranging two types of planar coils SU1 and SU2 along the right direction, which is a predetermined direction, and electrically connecting the planar coils, in other words, in series.

The planar coil array AR has both a function as coils for generating a magnetic field and a function as a path of an electric signal for transmitting the electric signal via the coils, in other words, a transmission path. A direction of the current in the planar coil array AR shown in the center of FIG. 1 is indicated by white arrows.

The planar coil SU1 is disposed at a left end of the planar coil array AR, the planar coil SU2 is disposed adjacent to the planar coil SU1 in the right direction, the planar coil SU1 is disposed adjacent to the planar coil SU2 in the right direction, and the planar coil SU2 is disposed adjacent to the planar coil SU1 in the right direction.

The planar coil array AR extends along the horizontal direction, which is a predetermined direction, and has a function as one coil that is long in the horizontal direction as a whole. Note that an arrangement direction of each planar coil is desirably linear, but the arrangement direction is not limited thereto, and a zigzag arrangement to some extent may be allowed.

The planar coil SU1 has a left-handed spiral shape around the center of the coil, and the number of turns is three, in other words, three turns. However, the present invention is not limited thereto.

The planar coil SU2 has a left-handed spiral shape around the center of the coil, and the number of turns is three, in other words, three turns. The planar coil SU2 is common to the planar coil SU1 in this respect, but the planar coil SU2 has a spiral shape having a deviation of 180 degrees with respect to the spiral of the planar coil SU1.

Here, the spiral being deviated by 180 degrees means that, in other word, a phase of the spiral is deviated by 180 degrees, in other words, means a relative positional relationship in which when one spiral is rotated to the left or the right by 180 degrees, the one spiral overlaps the other spiral.

The spirals in which the spiral directions are opposite to each other, in other words, the right-handed and left-handed spirals are in a relative positional relationship in which when one spiral is reversed horizontally, the one spiral overlaps the other spiral, the relative positional relationship being different from the relative positional relationship in which the phase is deviated by 180 degrees.

Further, a center of the left-end planar coil SU1 and a center of the planar coil SU2 adjacent to the right thereof are electrically connected by a connection conductor 83.

The connection conductor 83 is formed of a conductor straddling a spiral pattern of each coil, and for example, a wire harness having a bow shape can be used. The connection conductor 83 may be referred to as a center connection conductor.

Further, an end portion of the planar coil SU2 adjacent to the right of the left-end planar coil SU1 on a side opposite to the center and an end portion of the planar coil SU1 adjacent to the right thereof on a side opposite to the center are electrically connected by a connection conductor CN1 formed of a conductor pattern on the same layer as each planar coil. The connection conductor CN1 may be referred to as an end portion connection conductor.

The end portion connection conductor CN1 is a conductor pattern, in other words, a wiring that connects a first end portion on the side opposite to the center of the planar coil SU1 to a second end portion on the side opposite to the center of the planar coil SU2 adjacent to the right thereof.

The end portion connection conductor CN1 has a lead-out wiring portion F1 led out linearly in the right direction from the first end portion, a wiring portion F2 extending in the +Y direction orthogonal to the lead-out wiring portion F1, in other words, in the positive width direction, and a wiring portion F3 extending in the right direction from the end portion of the wiring portion F2 and connected to the second end portion. Each of F1 to F3 is surrounded by a broken-line ellipse.

The end portion connection conductor CN1 is led out in the right direction from the first end portion of the planar coil SU2 by the wiring portion F1, extends in the +Y direction by the wiring portion F2, and the wiring portion F3 is led out in the right direction from the end portion of the wiring portion F2 and is electrically connected to the second end portion of the planar coil SU1.

In the state shown in FIG. 1, since the current flows from the terminal B to the terminal A, in the end portion connection conductor CN1, the current flows from the wiring portion F3 to the left via the wiring portions F2 and F1, and reaches an end portion of the planar coil SU2.

In the planar coil SU2, the current also flows to the left. Accordingly, the wiring portions F2 and F1 can be referred to as wiring portions that realizes a current flow in the same rotation direction as the rotation direction of the current in the next planar coil SU2 that is a connection destination. With this configuration, a path length of the end portion connection conductor CN1, in other words, a length of the conductor pattern can be suppressed to a minimum limit. Further, the shape of the end portion connection conductor CN1 is a shape matching the shape of the spiral of the planar coil. Accordingly, a loss of the electric signal can be suppressed to a minimum limit.

Further, in the planar coil array AR, planar coils are disposed at an interval d in the horizontal direction. The above interval d is realized by the wiring portions F1 and F3 of the end portion connection conductor CN1. Accordingly, the planar coils are disposed regularly in a balanced manner with the interval d therebetween.

In this way, as the conductor pattern that electrically connects the end portions of the two adjacent planar coils, the end portion connection conductor CN1 completely matches the spiral patterns of the planar coils SU2 and SU1, and a large loss of the electric signal does not occur in the end portion connection conductor CN1.

A lower side of FIG. 1 shows an equivalent circuit of the planar coil array. When designing the circuit of the planar coil array, it is necessary to design the planar coil array as a distributed constant circuit serving as a circuit model of a transmission path of a high-frequency signal in consideration of a relatively high frequency of an electric signal flowing through the planar coil array.

Here, the equivalent circuit shown on the lower side of FIG. 1 is a circuit including inductance Na to Nd of the four coils and the connection paths DT1 to DT3 connecting the inductances. The connection paths DT1 to DT3 correspond to the center connection conductor 83 and the end portion connection conductor CN1. Parasitic capacitances Ca to Cd are formed in respective inductances and connection paths.

The equivalent circuit shown on the lower side of FIG. 1 is a distributed constant circuit in which the inductances and the capacitances are distributed in a balanced manner. Accordingly, a large transmission loss does not occur in an AC electric signal flowing between the power supply terminals A and B.

In other words, the planar coil array AR has a function as a low-loss transmission path. When the planar coil array AR is applied to, for example, a stroke sensor, the electric signal can be detected at a high S/N ratio. In other words, the high-gain displacement sensor is realized.

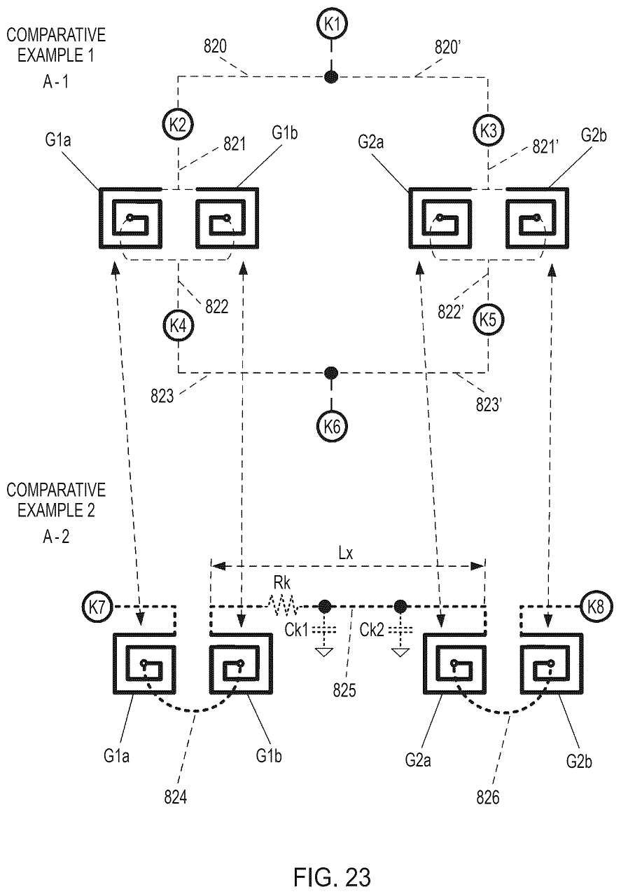

Here, in order to clarify features of the planar coil array AR in the embodiment of the present invention, a comparative example of FIG. 23 will be referred to. FIG. 23 is a diagram showing a configuration example of a planar coil array as the comparative example. This comparative example is studied by the present inventors before the present invention, and constitutes a part of the present invention.

As shown in FIGS. 1, 2, and 5 of WO2020/035968 described above, the planar coil array is known in the related art, and the planar coils used in the related art are planar coils wound in opposite directions.

That is, as shown in A-1 of FIG. 23, by arranging a right-handed planar coil G1a, a left-handed planar coil G1b, a right-handed planar coil G2a, and a left-handed planar coil G2b around the center along a predetermined direction, a coil long in the predetermined direction can be manufactured.

However, in the planar coil array in the related art, as can be seen from FIG. 1 of WO2020/035968, the planar coil arrays are connected in parallel to power supply terminals, and the planar coils are not electrically connected.

In this configuration, wirings B20, B20′, B21, B21′, B22, B22′, B23, and B23′ for parallel connection and terminals K1 to K6 are necessary, and it is undeniable that the configuration for electrically connecting the planar coils is complicated and increased in size.

Further, as described above, since each planar coil is not electrically connected, the planar coils cannot be used for applications in which electric signals need to be transmitted via each planar coil, such as a displacement sensor.

As a countermeasure, the present inventors have considered a configuration in which planar coils are connected in series between terminals as indicated by A-2. Conductors B24, B25, and B26 are used for electrical connection between the planar coils. The configuration indicated by A-2 is a part of the present invention and does not belong to the related art.

In this case, the transmission path of the electric signal is formed as a whole. However, an end portion of the planar coil G1b is located on a left side with respect to a center of the planar coil G1b, and an end portion of the planar coil G2b is located on a right side with respect to a center of the planar coil G2b. In other words, the end portions are located on the opposite sides in the left-right direction, and the end portions are disposed with a long distance Lx therebetween. Accordingly, large parasitic resistance Rk and large parasitic capacitances Ck1 and Ck2 are formed.

In other words, a wiring portion connecting the end portions does not match the spiral shape of each planar coil, and a large loss of the high-frequency signal occurs in the wiring portion. That is, the low-loss transmission path cannot be formed.

Here, referring back to FIG. 1, the description will be continued. In the planar coil array AR shown in the center of FIG. 1, the conductor pattern for electrically connecting the planar coils is simplified, and an overall size is reduced.

Further, as described above, the end portion connection wiring CN1 is particularly simplified. The end portion connection wiring CN1 completely matches the spiral shape of the planar coil, and the transmission loss of the electric signal can be suppressed to a minimum. In other words, the low-loss transmission path can be realized.

In this way, the winding direction of the spiral is the same, but by using the spiral shape whose phase is deviated by 180 degrees, an excellent effect of simplifying an electrical connection configuration and realizing the low-loss transmission path can be obtained.

In the following description, the planar coil SU1 means a first type of planar coil and is referred to as a first planar coil, and the planar coil SU2 means a second type of planar coil and is referred to as a second planar coil.

For example, focusing on the arrangement of the four planar coils shown in the center of FIG. 1, the left-end planar coil SU1 may be referred to as the first planar coil, the planar coil SU2 adjacent to the right may be referred to as the second planar coil, the planar coil SU1 adjacent to the right thereof may be referred to as a third planar coil, and the planar coil adjacent to the right thereof may be referred to as a fourth planar coil.

Whether the expression focuses on a type of the shape of the spiral or focuses on the arrangement of the spiral is determined based on the context.

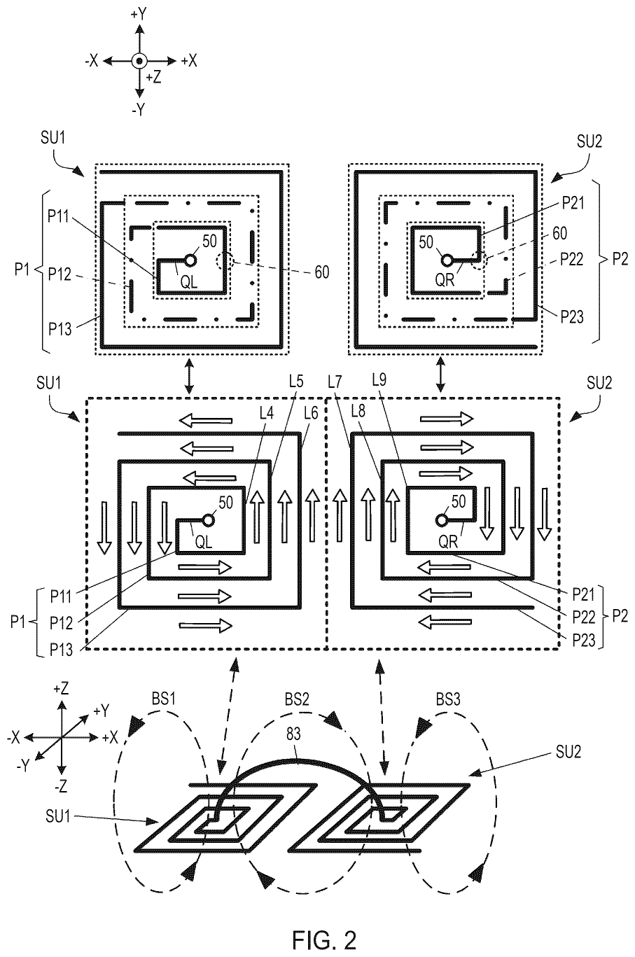

Next, FIG. 2 will be referred to. FIG. 2 is a diagram showing an arrangement of the two planar coils disposed adjacent to each other in FIG. 1, a direction of a flowing current, and electrical connection. In FIG. 2, the same components as those in FIG. 1 are denoted by the same reference numerals.

An upper side of FIG. 2 shows the spiral shapes in a plan view when the planar coils SU1 and SU2 are arranged side by side and each planar coil is viewed from the +Z direction. The center of each of the planar coils SU1 and SU2 is denoted by a reference numeral 50.

In each of the planar coils SU1 and SU2, a broken-line rectangle is shown, and the broken-line rectangle is shown to indicate a range of one turn of a winding. The planar coils SU1 and SU2 both have three turns, and the number of turns is the same.

In the planar coil SU1, a first winding portion P11 and a third winding portion P13 are indicated by thick solid lines, and a second winding portion P12 is indicated by a thick dash-dotted line.

In the planar coil SU2, a first winding portion P21 and a third winding portion P23 are indicated by thick solid lines, and a second winding portion P22 is indicated by a thick dash-dotted line.

The planar coil SU1 has a configuration in which a conductor pattern, in other words, the winding P1, is wound around the center 50 of the planar coil SU1 three turns left-handed. The planar coil SU2 has a configuration in which a conductor pattern, in other words, the winding P2, is wound around the center 50 of the planar coil SU1 three turns left-handed. In this point, it is common to the planar coil SU1. However, the spiral shape of the planar coil SU2 has a shape deviated by 180 degrees with respect to the spiral shape of the planar coil SU1.

In the planar coils SU1 and SU2, portions 60 surrounded by broken-line circles are shown. In the planar coil SU1, a lead-out wiring QL led out in the left direction is connected to the center 50, and the first winding portion P11 travels a half circumference to reach the portion 60. On the other hand, in the planar coil SU2, the lead-out extraction wiring QL led out in the right direction is connected to the center 50, and the lead-out position is the portion 60. Accordingly, the phase of the spiral shape is deviated by a half circumference, that is, 180 degrees. In other words, the planar coils SU1 and SU2 have a relative positional relationship in which when one is rotated to the left or the right by 180 degrees, it overlaps with the other.

As shown in the center of FIG. 2, of the planar coil SU1, currents in the same direction from a −Y side to a +Y side flow in wirings L4 to L6 located on the planar coil SU2 side with respect to the center 50, that is, to the right of the center 50.

The same applies to the planar coil SU2, and currents in the same direction from the −Y side to the +Y side flow in wirings L7 to L9 located on the planar coil SU1 side with respect to the center 50, that is, to the right of the center 50.

The plurality of wirings L4 to L9 can be collectively referred to as wirings of an adjacent region in the adjacent planar coils SU1 and SU2. The current flowing in the same direction is generated in each wiring in the adjacent region of the planar coils SU1 and SU2, and accordingly, a magnetic field in the common direction is generated in each of the wirings L4 to L9 according to the Ampere's right-hand screw rule. By combining the magnetic fields, the magnetic field is enhanced in the horizontal direction. Accordingly, as shown on a lower side of FIG. 2, a strong magnetic field BS2 can be generated in the adjacent region of the planar coils SU1 and SU2.

In the following description, a clockwise magnetic field of the magnetic fields generated according to the right screw rule of Ampere is referred to as a rightward magnetic field or a clockwise magnetic field. A counterclockwise magnetic field is referred to as a leftward magnetic field or a counterclockwise magnetic field.

In the example shown on the lower side of FIG. 2, a leftward magnetic field BS1 is generated in a portion located to the left of the center 50 of the planar coil SU1, the rightward magnetic field BS2 is generated in the adjacent region of the planar coils SU1 and SU2, and a leftward magnetic field BS3 is generated in the portion located to the right of the center 50 of the planar coil SU2. In this way, the magnetic fields in opposite directions are alternately generated in the horizontal direction, that is, along the predetermined direction.

In the example of the lower side of FIG. 2, a wire harness 83 having a bow shape is used as a center connection conductor connecting the centers of the planar coils SU1 and SU2. A bonding wire can be used instead of the wire harness.

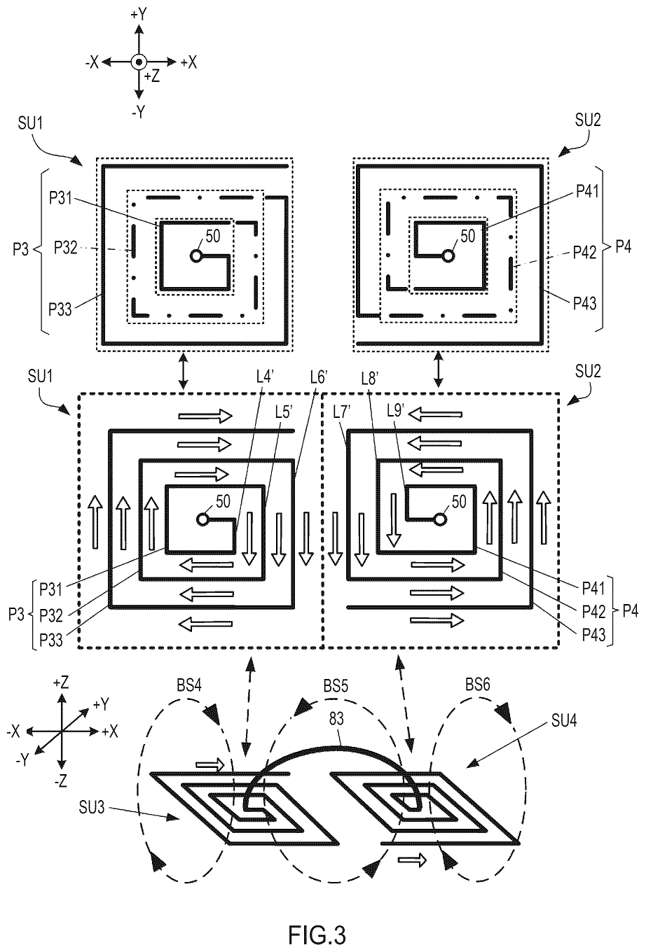

Next, FIG. 3 will be referred to. FIG. 3 is a diagram showing another example of the arrangement of the two planar coils disposed adjacent to each other, the direction of the flowing current, and the electrical connection. An upper side of FIG. 3 shows the spiral shapes when the planar coils SU1 and SU2 are arranged side by side and each planar coil is viewed from the +Z direction. The center of each of the planar coils SU1 and SU2 is denoted by the reference numeral 50.

In FIG. 3, the planar coils SU1 and SU2 are both right-handed, and the winding directions are different from those in the example of FIG. 2. The phase of the spiral of the planar coil SU2 is deviated by 180 degrees with respect to the phase of the spiral of the planar coil SU1.

Accordingly, the direction of the current flowing through each of the planar coils SU1 and SU2 is opposite to that in the example of FIG. 2, and the direction of the generated magnetic field is also opposite. Since the description of FIG. 2 is also applicable to FIG. 3, detailed description thereof will be omitted.

Reference numerals P3 and P4 in FIG. 3 correspond to the reference numerals P1 and P2 in FIG. 2. Reference numerals P31 to P33 and P41 to P43 in FIG. 3 correspond to the reference numerals P11 to P13 and P21 to P23 in FIG. 2. Reference numerals L4′ to L9′ in FIG. 3 correspond to the reference numerals L4 to L9 in FIG. 2. Reference numerals BS4 to BS6 in FIG. 3 correspond to the reference numerals BS1 to BS3 in FIG. 2.

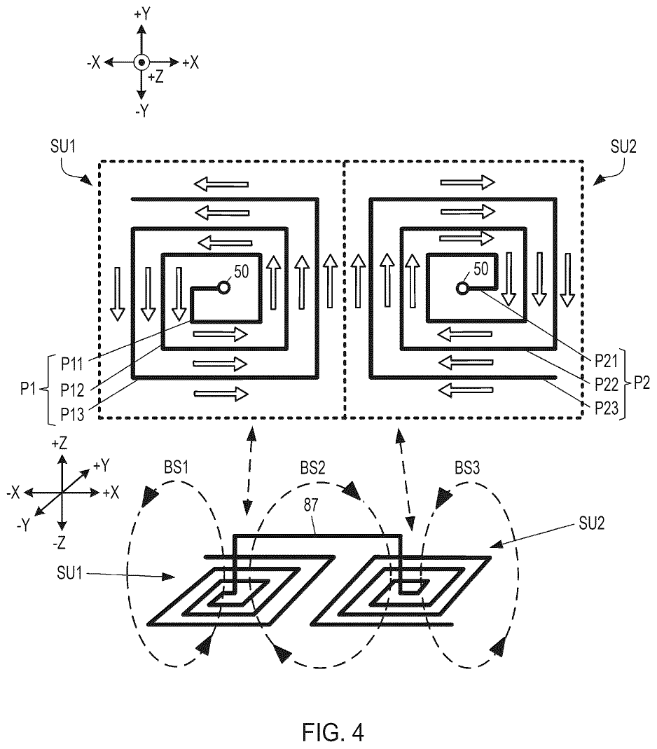

Next, FIG. 4 will be referred to. FIG. 4 is a diagram showing another example of the electrical connection between the two planar coils disposed adjacent to each other in FIG. 2.

The diagram shown on an upper side of FIG. 4 is the same as the diagram shown in the center of FIG. 2 described above. However, in the diagram shown on the lower side of FIG. 4, a bridge electrode, an electrode having a multilayer structure, or a wiring having a multilayer structure is used as a center connection conductor 87 that connects the center of the planar coil SU1 to the center of the planar coil SU2. In this regard, the configuration is different from that of the example of FIG. 2. The effect obtained is the same as in FIG. 2.

### Embodiment 2

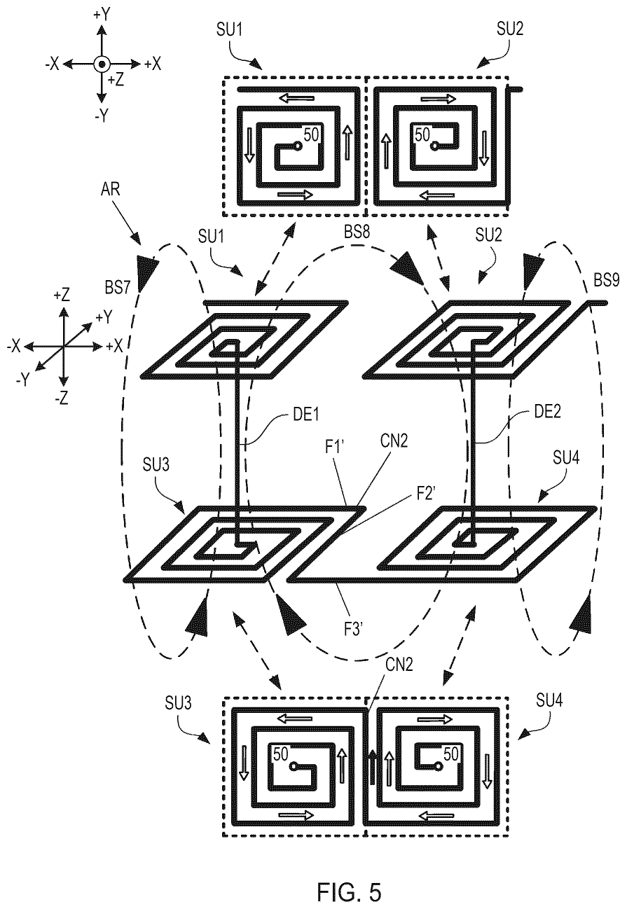

In the present embodiment, a planar coil array having a multilayer structure will be described. FIG. 5 is referred to. FIG. 5 is a diagram showing an example of an arrangement of the planar coil array having the multilayer structure using four planar coils, current flows, and electrical connection.

In the example of FIG. 5, the planar coil array having the multilayer structure is formed. The multilayer structure may be a multilayer structure according to a double-sided mounting technique for a printed board, or may be a multilayer structure according to a multilayer wiring technique for forming an interlayer insulating layer and a multilayer wiring layer on a board.

In FIG. 5, the left-handed planar coils SU1 and SU2 previously shown on the upper side of FIG. 2 are used as planar coils on an upper layer.

Further, the right-handed planar coils previously shown on the upper side of FIG. 3 are used as planar coils on a lower layer. In other words, the planar coils on the lower layer are formed so as to overlap the planar coils on the upper layer in a plan view, and the planar coils on the upper layer and the planar coils on the lower layer corresponding to the planar coils have opposite spiral winding directions of the planar coils. In other words, a relative positional relationship is obtained in which when one spiral is reversed horizontally, the one spiral overlaps the other spiral.

However, in FIG. 3, the right-handed planar coils were indicated by the reference numerals SU1 and SU2, but in FIG. 5, since it is necessary to distinguish them from the planar coils SU1 and SU2 on the upper layer, the planar coils on the lower layer are denoted by reference numerals of SU3 and SU4.

An upper side of FIG. 5 shows spiral shapes when the planar coils SU1 and SU2 on the upper layer are arranged side by side and each planar coil is viewed from the +Z direction. Further, a lower side of FIG. 5 shows spiral shapes when the planar coils SU3 and SU4 on the lower layer are arranged side by side and each planar coil is viewed from the +Z direction. The center of each of the planar coils SU1 to SU4 is denoted by the reference numeral 50.

Directions of the currents flowing in the planar coils SU1 to SU4 are indicated by white arrows. When the planar coils SU1 and SU3 are overlapped, current flows in the same direction in wirings that overlap vertically. Similarly, when the planar coils SU3 and SU4 are overlapped, current flows in the same direction in wirings that overlap vertically.

Each of the four planar coils SU1 to SU4 has a different spiral shape. That is, in the example of FIG. 4, the electrical path can be formed by combining four types of spiral shapes, and a degree of freedom in designing the device is improved.

The planar coils SU1 to SU4 may be referred to as first to fourth planar coils for convenience.

The planar coils SU1 and SU3 are stacked so as to overlap each other in the plan view, the planar coil SU1 is left-handed, the planar coil SU2 is right-handed, and centers of the planar coils SU1 and SU3 are electrically connected to each other by a center connection conductor DE1 extending in the Z direction, that is, along the upper-lower direction.

The planar coils SU2 and SU4 are stacked so as to overlap each other in the plan view, the planar coil SU2 is left-handed, the planar coil SU4 is right-handed, and the centers of the planar coils SU2 and SU4 are electrically connected to each other by a center connection conductor DE2 extending in the Z direction, that is, along the upper-lower direction.

Further, the planar coil SU3 and the planar coil SU4 are formed of a conductor on the same layer, and respective end portions are electrically connected by an end portion connection conductor CN2. The end portion connection conductor CN2 is formed of a conductor on the same layer as the planar coils SU3 and SU4, has a similar shape and function as the end portion connection conductor CN1 described above, and produces similar effects.

In FIG. 5, the end portion connection conductor CN2 has wiring portions F1′, F2′, and F3′. The portions respectively correspond to the wiring portions F1, F2, and F3 of the end portion connection conductor CN1 described in FIG. 1. The end portion connection conductor CN2 matches the spiral of the planar coils SU3 and SU4, and a loss of an electric signal is suppressed, thereby ensuring a low-loss transmission path.

Further, the center connection conductors DE1 and DE2 can be implemented, for example, by an electrode referred to as a contact plug formed by embedding a conductor in a via hole formed in a printed board, or a contact electrode formed through a contact hole formed in an interlayer insulating film.

When the planar coils SU1 and SU3 are stacked, since current flows in the same direction in each of the wirings that overlap vertically, magnetic fields in the same direction that mutually enhance each other in the upper-lower direction are generated. Similarly, when the planar coils SU3 and SU4 are stacked, since current flows in the same direction in each of the wirings that overlap vertically, magnetic fields in the same direction that mutually enhance each other in the upper-lower direction are generated.

Further, even in the wiring portion F2′ of the end portion connection conductor CN2, a current flows in the same direction in each of the wirings that overlap vertically, and magnetic fields in the same direction are generated.

A strong magnetic field BS8 is generated by combining the magnetic fields in the same direction generated in this way and enhancing the magnetic fields in the horizontal direction and the upper-lower direction.

In the example of FIG. 5, a leftward magnetic field BS7 is generated in portions of the planar coils SU1 and SU2 which are located to the left of the center 50.

Further, the rightward magnetic field BS8 is generated in the adjacent region of the planar coils SU1 and SU2, an adjacent region of the planar coils SU3 and SU4, and the wiring portion F2′ of the end portion connection conductor CN2 interposed between the planar coils SU3 and SU4.

Further, a leftward magnetic field BS9 is generated in portions of the planar coils SU2 and SU4 which are located to the right of the center 50. In this way, the magnetic fields in opposite directions are alternately generated in the horizontal direction, that is, along the predetermined direction.

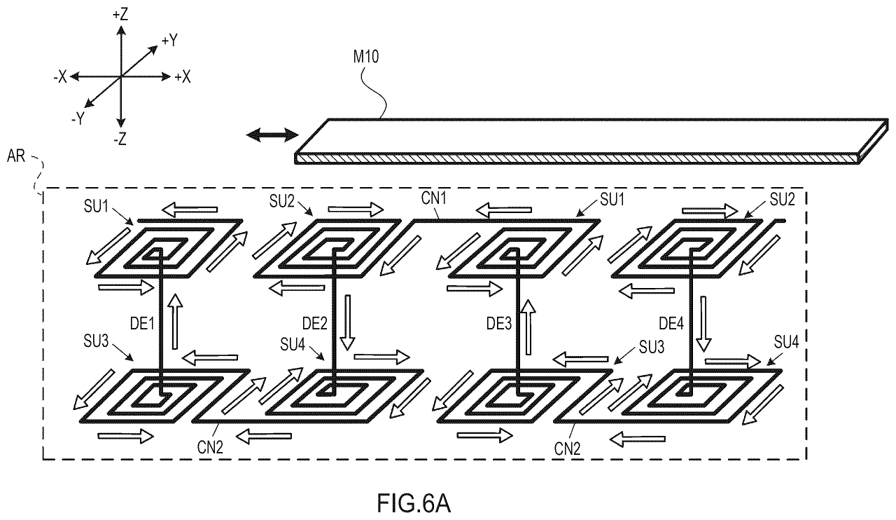

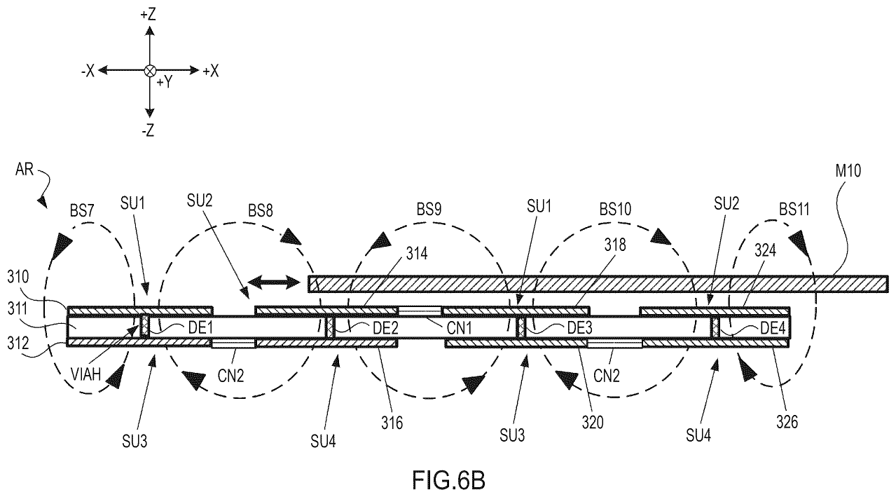

Next, FIG. 6A will be referred to. FIG. 6A is a diagram showing a configuration in which a movable conductor is disposed near a planar coil array having a multilayer structure using eight planar coils. In FIG. 6A, the same parts as those in the foregoing drawings are denoted by the same reference numerals.

In the example of FIG. 6A, another multilayer structure including the four planar coils shown in FIG. 5 is prepared, the multilayer structures are disposed adjacent in the horizontal direction, and the multilayer structures are electrically connected in the horizontal direction using the end portion connection conductor CN1.

The centers of the planar coils stacked vertically are connected to each other by the center connection conductors DE1 and DE2 as described above. However, in FIG. 6A, in order to distinguish the four used center connection conductors from each other, the center connection conductors from left to right are denoted by reference numerals of DE1 to DE4.

Accordingly, one planar coil array AR that has a multilayer structure including eight planar coils and also serves as a transmission path for an electric signal is formed. A current flowing direction is indicated by a white arrow.

A plate-shaped conductor M10 that is movable and is horizontally long is disposed in the vicinity of the planar coil array AR. This configuration is substantially the same as the configuration in which the movable cylindrical conductor M1 previously shown on the upper side of FIG. 1 is fitted to the horizontally long coil CL1.

In the example of FIG. 6, when the plate-shaped conductor M10 that is horizontally long moves in the horizontal direction, inductance of each planar coil in the planar coil array AR varies, and electrical characteristics of the electric signal transmitted via the planar coil array AR, for example, a frequency changes. By detecting the change in the frequency, the movement amount of the conductor M10 can be detected. Accordingly, the planar coil array AR of FIG. 6 may be a component of the displacement sensor.

Next, FIG. 6B will be referred to. FIG. 6B is a cross-sectional view of the planar coil array and the movable conductor in FIG. 6A.

In the example of FIG. 6B, the multilayer structure is formed using the double-sided mounting technique for a printed board 311, and the following description will be made. When the multilayer wiring technique using the interlayer insulating film is used, the reference numeral 311 indicates an interlayer insulating layer formed on a semiconductor board or an insulating board.

When the printed board 311 is a rigid board having no flexibility on a flat plate, for example, a glass epoxy resin or a polyimide resin can be used as a material thereof. When the printed board 311 is a flexible board having flexibility, for example, a polyimide resin film or a polyester resin film can be used as the material thereof. However, this is merely an example, and the present invention is not limited to these examples.

The planar coil SU1 on the upper layer located at a left end is formed of a metal conductor 310 formed on a front surface of the printed board 311. For example, silver or copper may be used as the metal. A thin film of silver or copper is formed on the printed board 311 and patterned by photolithography to form a pattern having a spiral shape.

The planar coil SU2 disposed so as to overlap the planar coil SU1 in a plan view as viewed from above is formed by the conductor 312. The center connection conductor DE1 that connects the centers of the planar coils SU1 and SU2 can be made of, for example, a metal electrode made of, for example, copper, which is buried and formed in a via hole VIAH formed to penetrate the printed board 311.

Conductors 314, 318, and 324 formed on the front surface of the printed board 311, the end portion connection conductor CN1, and conductors 316, 320, and 326, and the end portion connection conductor CN2 formed on a back surface of the printed board 311 are also made of the above metal material, and are patterned into a predetermined pattern by photolithography.

When the multilayer structure using the double-sided mounting technique or the like for the printed board is used, the thin and small-sized planar coil array AR can be manufactured at low cost, easily, and stably by using the existing semiconductor processing technique.

Further, since the planar coil array AR has a flat plate shape, it is possible to dispose the flat-plate-shaped movable conductor M10 closely without difficulty. Accordingly, for example, a small-sized displacement sensor can be formed.

In the example of FIG. 6B, the leftward magnetic field BS7, the rightward magnetic field BS6, the leftward magnetic field BS9, a rightward magnetic field BS10, and a leftward magnetic field BS11 are generated from left to right. That is, the magnetic fields having opposite directions are alternately generated in the horizontal direction. The strength of each magnetic field is uniform, and a stable magnetic field can be generated in a balanced manner.

The above description is summarized as follows.

That is, the planar coil array AR according to the present invention includes: the first planar coil SU1 having a first spiral shape in which the first conductor 310 is wound around a first center 50 in a left-handed manner or a right-handed manner; the second planar coil SU2 having a second spiral shape in which the second conductor 314 on the same layer as the first conductor is wound around a second center 50 in the same manner as the first planar coil SU1 and has an angular deviation from the first spiral shape; and the first connection conductor 83 configured to electrically connect the first and second planar coils SU1 and SU2, in which when a current flows from the first center toward a first end portion on a side opposite to the first center in the first planar coil SU1, a current flows from a second end portion on a side opposite to the second center toward the second center in the second planar coil SU2, and when a current flows from the first end portion toward the first center in the first planar coil SU1, a current flows from the second center toward the second end portion in the second planar coil SU2.

The angular deviation in each of the first and second spiral shapes is a deviation of 180 degrees in a preferable example.

Accordingly, the direction of the current flowing through each of the plurality of wirings in the adjacent region of the first and second planar coils becomes the same, and a strong magnetic field can be generated in the adjacent regions.

Further, as the first connection conductor that electrically connects the first and second planar coils, the center connection conductor that connects the centers of the planar coils and the end portion connection conductor that connects the end portions of the planar coils can be assumed. According to the above configuration, particularly, the conductor pattern as the end portion connection conductor that connects the respective end portions of the planar coils is simplified, and the overall size can be reduced.

Further, since the simplified conductor pattern matches the spiral shape of the planar coil, the loss of the electric signal can be suppressed.

Accordingly, the excellent effect of simplifying the electrical connection configuration and realizing the low-loss transmission path can be obtained.

Further, the first connection conductor 83 electrically connects a first center of the first planar coil SU1 to a second center of the second planar coil SU2.

Accordingly, the centers of the first and second planar coils are electrically connected to each other to form one planar coil array extending in a predetermined direction.

Further, the first connection conductor 83 is formed by a conductor wire, a conductor electrode, or a conductor wiring having a multilayer structure, which is provided to straddle a winding of each of the first and second planar coils SU1 and SU2.

Accordingly, the centers of the first and second planar coils SU1 and SU2 can be connected by an electrical path provided to straddle the winding of each planar coil. Thus, one planar coil array extending in the predetermined direction can be formed.

Further, the first connection conductor CN1 electrically connects the first end portion of the first planar coil SU1 to the second end portion of the second planar coil SU2, and has the same layer as the first and second conductors 310 and 314.

Accordingly, the end portions of the first and second planar coils are electrically connected to each other by a conductor on the same layer as each planar coil, thereby forming one planar coil array extending in the predetermined direction.

When the end portion of one of the planar coils is located to the right of the center of the planar coil, since the end portion of the other of the planar coils is located to the left of the center of the planar coil, the end portions are arranged close to each other. Thus, it is possible to shorten a length of the first connection conductor that connects the end portions of the planar coils, in other words, the length of the end portion connection conductor.

Further, it is possible to dispose the end portion connection wiring to match the spiral shape of the planar coil, and the transmission loss of electric signals can be suppressed to a minimum.

In this manner, the end portion connection wiring can be simplified. In addition, the low-loss path of the electric signal can be easily formed.

Further, the planar coil array AR may include the third planar coil SU3 in which the third conductor 312 of a layer different from that of the first conductor 310 is spirally wound around a third center in a direction opposite to that of the first planar coil SU1, and is disposed to overlap the first planar coil SU1 in a plan view; and the fourth planar coil SU4 in which the fourth conductor 316 on the same layer as the third conductor 312 is spirally wound around a fourth center in a direction opposite to that of the second planar coil SU2, and is disposed to overlap the second planar coil SU2 in the plan view.

Accordingly, the multilayer structure in which the planar coils formed of different layers of conductor patterns are stacked in the upper-lower direction is realized. Since the wirings of the planar coils stacked in the upper-lower direction, which overlap in the plan view, allow current to flow in the same direction and generate magnetic fields in the same direction, the combined magnetic fields generate the strong magnetic field. In other words, the strength of the magnetic field can be improved.

Further, the planar coil array includes: the second connection conductor DE1 configured to electrically connect the first center of the first planar coil SU1 to the third center of the third planar coil SU3; the third connection conductor DE2 configured to electrically connect the second center of the second planar coil SU2 to the fourth center of the fourth planar coil SU4; and the fourth connection conductor CN2 that has the same layer as the third and fourth conductors 312 and 316 and is configured to electrically connect the third end portion of the third planar coil SU3 and the fourth end portion of the fourth planar coil SU4, in which the first and second end portions of the first and second planar coils SU1 and SU2 are electrically connected to each other by an electrical path including the second, third, and fourth connection conductors DE1, DE2, and CN2 and the first to fourth planar coils SU1, SU2, SU3, and SU4.

Accordingly, the end portions of the first and second planar coils can be connected to each other through the electrical path using the multilayer structure including the first planar coil, the second connection conductor, the third planar coil, the fourth connection conductor, the fourth planar coil, the third connection conductor, and the second planar coil. In other words, the electrical path functions as the first connection conductor described above that connects the centers of the first and second planar coils to each other.

The centers of the two planar coils overlapping in the upper-lower direction can be electrically connected to each other at the shortest distance by a via electrode, a contact electrode, or the like as the second and third connection conductors. Further, each end portion of the third and fourth planar coils is also electrically connected to the fourth connection conductor which is a simplified wiring, and the loss of the electric signal in the fourth connection conductor is also suppressed. Accordingly, the path of the electric signal is a path of an electric signal balanced without waste, and is particularly suitable for transmission of the high-frequency signal.

The third and fourth planar coils are formed in the path of the electric signal. The first and third planar coils are stacked in the upper-lower direction, and the second and fourth planar coils are stacked in the upper-lower direction. In this case, the third planar coil serves to reinforce the magnetic field of the first planar coil. The fourth planar coil serves to reinforce the magnetic field of the second planar coil. Accordingly, the strong magnetic field can be generated.

In this way, when the electrical path connecting the end portions of the two planar coils to each other can be formed using a simplified wiring, the strength of the magnetic field can be further improved by further forming two planar coils in the electrical path.

Further, in the planar coil array, each of the second, third, and fourth connection conductors DE1, DE2, and CN2 and each of the third and fourth planar coils SU3 and SU4 may be formed in a multilayer structure according to a double-sided mounting technique for a printed board or a multilayer structure according to a multilayer wiring technique of forming an interlayer insulating layer and a multilayer wiring layer on a board.

Accordingly, the multilayer structure can be formed simply, inexpensively and with high reliability by using the semiconductor processing technique.

### Embodiment 3

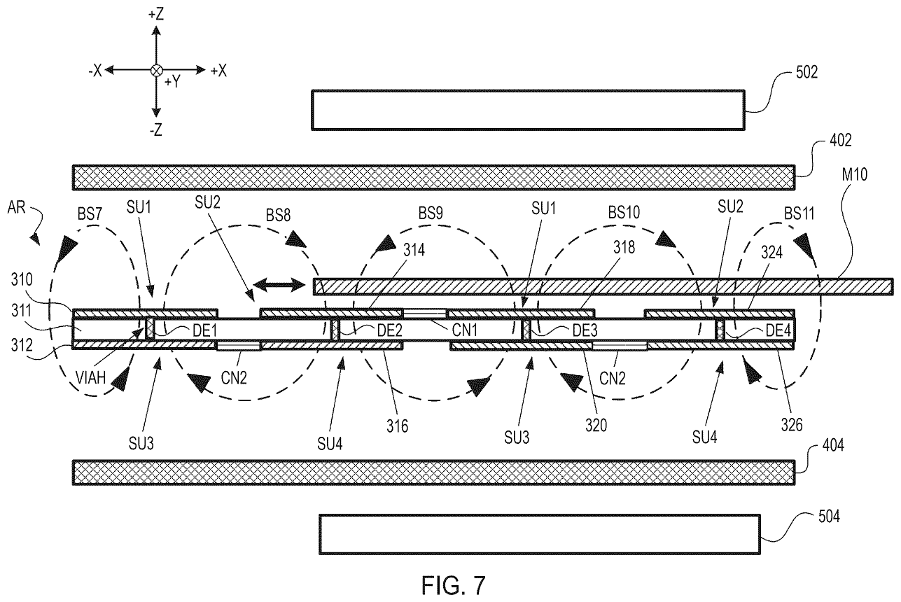

In the present embodiment, a magnetic shield structure of a planar coil array will be described. FIG. 7 is referred to. FIG. 7 is a cross-sectional view of a structure in which shield members for shielding a magnetic field are provided between the planar coil array and an object to be protected disposed around the planar coil array.

The planar coil array AR in FIG. 7 is the same as the planar coil array in FIG. 6B. Since the configuration of the planar coil array AR has been described above, description thereof will be omitted here.

Objects to be protected 502 and 504 are provided around the planar coil array AR. The object to be protected may be referred to as a peripheral conductor.

The object to be protected is a member or a device that needs protection against the magnetic field generated by the planar coil array AR. Examples of the object to be protected include a conductor member disposed around the planar coil array and requiring protection from the magnetic field, a semiconductor device or an integrated circuit device requiring protection against the magnetic field, or an electronic device.

A magnetic shield member 402 is provided between the planar coil array AR and the object to be protected 502 disposed around the planar coil array AR, and a magnetic shield member 404 is provided between the planar coil array AR and the object to be protected 504.

The magnetic shield member may be simply referred to as a shield member. The magnetic shield member may be an electromagnetic shield member that shields both an electric field and the magnetic field.

As the material of the magnetic shield member, for example, a metal such as iron or a magnetic material can be used. The magnetic shield member may be provided with a slit that satisfies a predetermined condition. This will be described later.

As the magnetic shield member, for example, an electrical insulating material containing magnetic powder, in other words, a magnetic resin compound may be used. This will be described later.

It is preferable that the magnetic shield members 402 and 404 are arranged along the X direction which is an extending direction of the planar coil array AR and cover the planar coil array AR so as to overlap the planar coil array AR in a plan view as viewed from the +Z direction or the −Z direction.

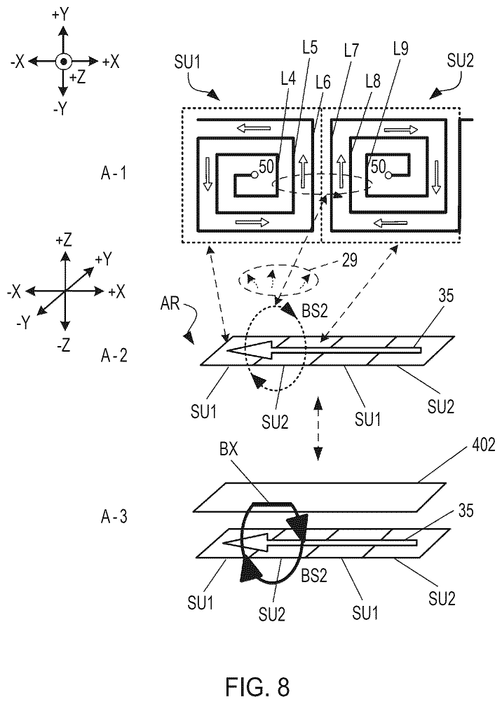

Next, FIG. 8 will be referred to. FIG. 8 is a diagram showing a configuration in which the magnetic shield member functions as a yoke as a component of the magnetic circuit.

A-1 of FIG. 8 is a plan view of a configuration in which the planar coils SU1 and SU2 are arranged side by side. This configuration is the same as the configuration previously described with reference to FIG. 2. A direction of the current is indicated by a white arrow.

A region between the centers 50 of the planar coils SU1 and SU2 is an adjacent region. In the adjacent region, there are six conductor patterns which are LA to L9 extending in the Y direction, in other words, wirings, and since current flows through each wiring from the −Y side to the +Y side, in this adjacent region, magnetic fields generated by the wirings are combined to generate the strong rightward magnetic field BS2.

In A-2 of FIG. 8, two pairs of planar coils are used in which one pair is composed of planar coils SU1 and SU2, and by disposing the two pairs of planar coils in the X direction, the planar coil array AR extending in the X direction is formed. Since the planar coil array AR has the same configuration as that of the planar coil array described with reference to FIG. 1, it is depicted in a simplified manner in FIG. 8.

In the planar coil array AR of A-2 of FIG. 8, a current 35 flows from a right side to a left side at a certain timing. As a result, the magnetic field BS2 is generated. A part of a magnetic flux constituting the magnetic field BS2 leaks into the atmosphere, and leakage flux 29 surrounded by a broken-line ellipse is present in this figure.

Here, as shown in A-3 of FIG. 8, when a configuration in which the magnetic shield member 402 is disposed close to the planar coil array AR is employed, the magnetic shield member has a significantly higher magnetic permeability than the atmosphere, and the magnetic flux is more likely to pass therethrough. Thus, the above leakage flux flows through the magnetic shield member 402, so that the leakage flux can be effectively utilized. Accordingly, magnetic flux density is improved. In A-3 of FIG. 8, a magnetic flux BX flowing from the left to the right is generated in the magnetic shield member 402.

In other words, the magnetic flux generated by the wirings L4 to L6 of the first planar coil SU1 and the magnetic flux generated by the wirings L7 to L9 of the adjacent second planar coil SU2 can be efficiently coupled. Thereby, the magnetic flux density is increased and the magnetic field BS2 is strengthened.

A portion of the magnetic shield member 402, where the magnetic flux BX flows, functions as the yoke coupling the magnetic fluxes of two adjacent planar coils in the planar coil array AR to increase the magnetic flux density.

The magnetic shield member having the function as the yoke is a multifunctional member having two functions that can be referred to as a magnetic shield member serving as a yoke or a shield member serving as a yoke. The shield member serving as a yoke may be referred to as a yoke shield member.

In this way, by disposing the magnetic shield member close to the planar coil array, the magnetic shield member can function as the yoke, thereby improving the magnetic flux density and generating a stronger magnetic field.

Further, when the magnetic shield member is disposed close to the planar coil array, an effect of size reduction that the structure constituted by the magnetic shield member and the planar coil array is reduced in size and can be installed in a narrow space is also obtained.

However, according to the study by the present inventors, it has become clear that, when the magnetic shield member is disposed close to the planar coil array, an undesirable effect may also be generated due to the planar coil array functioning as a transmission path of an AC signal.

That is, when a conductive magnetic shield member is disposed in the vicinity of a planar coil array which extends along a predetermined direction and also serves as a path of an electric signal, that is, close to the planar coil array, a structure similar to a microstrip line which is a transmission path of a high-frequency signal is formed in a pseudo manner when the frequency of the electric signal is high, a current referred to as a return current flows through the conductive magnetic shield member, a magnetic field generated by the return current acts to cancel out the magnetic field of the planar coil array, and there occurs a new problem that a strength of the magnetic field generated by the planar coil array decreases. This problem will be described below.

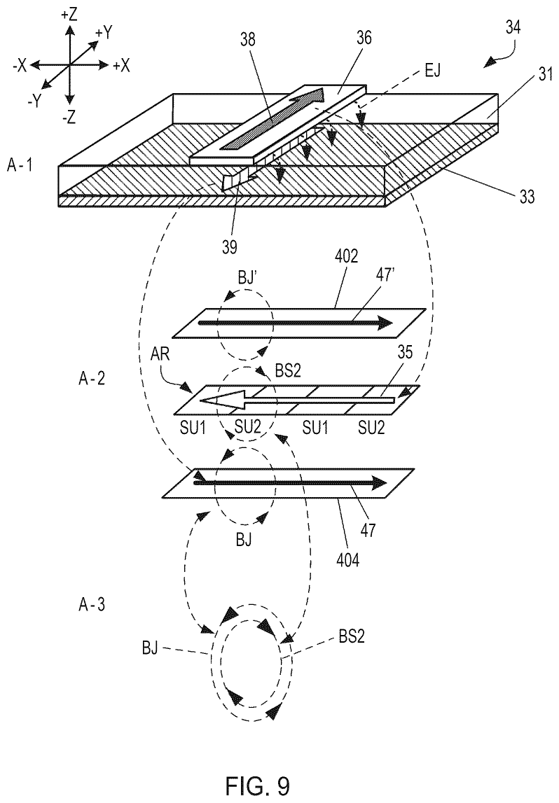

FIG. 9 is referred to. FIG. 9 is a diagram showing an example of an undesirable effect due to the planar coil array functioning as the transmission path of the AC signal.

A-1 of FIG. 9 shows a typical structure of the microstrip line. A microstrip line 34 has a flattened structure in which divided pieces obtained by dividing a coaxial cable into two in a cross-sectional shape are flattened.

In A-1 of FIG. 9, a signal transmission path 36 corresponds to the inner conductor of the coaxial cable, and a high-frequency signal 38 is transmitted via the signal transmission path 36. A flat plate-shaped ground conductor 33 is provided below the signal transmission path 36. The ground conductor 33 corresponds to an external conductor of the coaxial cable and has a function of shielding the magnetic field generated by the internal conductor.

The signal transmission path 36 and the ground conductor 33 are arranged to face each other via a board 31 made of a dielectric, which is an electrical insulator.

When a high-frequency current flows through the signal transmission path 36, a magnetic field EJ from the signal transmission path 36 to the ground conductor 33 is generated. When the magnetic field EJ crosses the ground conductor 33, many eddy currents are generated on a front surface of the ground conductor 33 due to a skin effect.

Due to the electric field generated by the eddy current, a current 39 flows so as to cancel out the magnetic field EJ. Since a direction of the current 39 is opposite to a direction of the high-frequency signal 38 flowing through the signal transmission path 36, the current 39 is generally referred to as the return current.

When the return current is generated, the magnetic field generated by the return current 39 cancels out the magnetic field EJ generated by the high-frequency signal 38, thereby weakening the strength of the magnetic field EJ.

Here, when the structure of the microstrip line is compared with a structure formed by the planar coil array AR and the magnetic shield member 404 shown in A-2 of FIG. 9, it is understood that both have similar structures.

That is, the planar coil array AR corresponds to the signal transmission path 36, and the magnetic shield member 404 corresponds to the ground conductor 33.

Further, the printed wiring board or the interlayer insulating film 311 previously shown in FIG. 7 corresponds to the dielectric board 31 in the microstrip line 34.

The magnetic shield member 402 is disposed above the planar coil array AR and close to the planar coil array AR. The magnetic shield member 402 also has the same function as the magnetic shield member 404 disposed below the planar coil array AR as an electrical configuration. Thus, the magnetic shield member 402 can also be regarded as corresponding to the ground conductor 33 in the microstrip line 34.

In A-2 of FIG. 9, a return current 47 is generated in the magnetic shield member 404 disposed below the planar coil array AR. That is, the magnetic field BS2 is generated by the current signal flowing from the right to the left of the planar coil array AR, in other words, the high-frequency current signal 35. When the magnetic field BS2 crosses the magnetic shield member 404, many eddy currents are generated on a front surface of the magnetic shield member 404 due to the skin effect, and the return current 47 flows due to the electric field generated by the eddy currents.

Then, the magnetic field BJ is generated by the return current 47. As shown in A-3 of FIG. 9, the magnetic field BS2 is a rightward magnetic field, the magnetic field BJ is a leftward magnetic field in an opposite direction. Accordingly, a magnetic field BSJ acts to cancel out the magnetic field BS2 generated by the planar coil array AR. Accordingly, the strength of the magnetic field BS2 is weakened, and the planar coil array AR cannot generate an original strong magnetic field.

A return current 47′ is also generated in the magnetic shield member 402 disposed above the planar coil array AR by the same principle. A magnetic field BJ′ generated by the return current 47′ is in an opposite direction to the magnetic field BS2 generated by the planar coil array AR. Therefore, the magnetic field BJ′ also acts to cancel out the magnetic field BS2. Accordingly, the strength of the magnetic field BS2 is further weakened.

As described above, the planar coil array is assumed to be applied to, for example, a displacement sensor. In order to improve a detection sensitivity of the displacement sensor, it is necessary to generate the strong magnetic field. When the magnetic field is weak, the detection sensitivity of the displacement sensor decreases. Accordingly, it is necessary to overcome the problem that the magnetic field generated by the planar coil array is weakened.

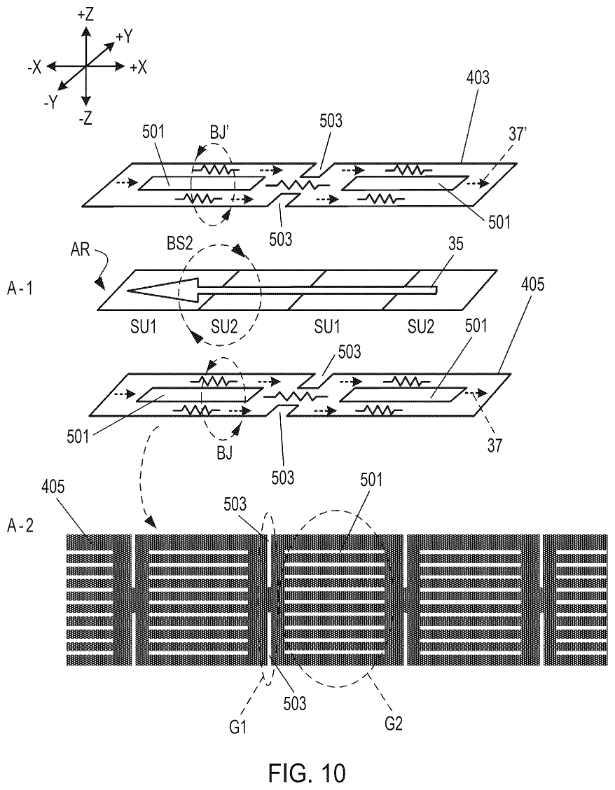

Next, a countermeasure for this problem will be described. FIG. 10 is referred to. FIG. 10 is a diagram showing an example of a configuration of shield members for suppressing undesirable effects shown in FIG. 9.

The present inventors have found that by suppressing the current flowing through the magnetic shield members, the problem described in FIG. 9 can be alleviated.

In the example of FIG. 10, a slit is provided in a conductive material plate constituting the magnetic shield member to increase a resistance value of the magnetic shield member in the direction in which the return current flows, thereby reducing a current amount of the return current.

Here, the slit is a void formed by cutting out a part of the material plate. In a preferred example, the slit has an elongated rectangular shape extending in one direction.

In the following description, the term “magnetic shield structure” may be used. The magnetic shield structure is preferably grasped from both the configuration of the magnetic shield member itself and an arrangement of the magnetic shield member with respect to the planar coil array, that is, a layout configuration including a relative positional relationship.

In A-1 of FIG. 10, a conductive magnetic shield member 403 having slits 501 and 503 is disposed above the planar coil array AR and close to the planar coil array AR. The magnetic shield member 403 functions as a path of an electric signal 37′ or a transmission path.

Further, a conductive magnetic shield member 405 having slits 501 and 503 is disposed below the planar coil array AR and close to the planar coil array AR. The magnetic shield member 405 functions as a path of an electric signal 37 or a transmission path.

The magnetic shield members 403 and 405 are conductive plate-shaped members extending in the X direction similarly to the planar coil array AR, and are disposed so as to cover the planar coil array AR and overlap the planar coil array in a plan view as viewed from the +Y direction or the −Y direction.

The magnetic shield members 403 and 405 are magnetic shield members that also serve as yokes having the function as the yoke previously described with reference to FIG. 8.

The slit 501 is a horizontally long rectangular slit that extends along the X direction, which is an extending direction of the magnetic shield members 403 and 405 or along one direction in a broad sense, and has a predetermined length. In A-1 of FIG. 10, the magnetic shield members 403 and 405 are each provided with two slits 501 and 501.

By providing the slits 501, a cross-sectional area of the path of the electric signal in the magnetic shield member 403 and 405 is reduced by the slits 501, and electrical resistance increases.

As shown in A-1 of FIG. 10, the electrical resistance is dispersed along the X direction and inserted into the path of the electric signal. This electrical resistance functions as a current limiting resistor that limits the return current described above. Accordingly, the return current is suppressed. As a result, the problem that the magnetic field generated by the planar coil array AR is cancelled out and weakened is alleviated.

The slit 501 is a slit extending in the X direction and can be referred to as a slit for suppressing the return current.

The slit 503 is a slit that intersects the X direction, in other words, one direction at a right angle, that is, orthogonal to the X direction. The slit 503 also has the same effect as the slit 501.

There are two slits 503, one of which is a slit cut into a center of the plate-shaped planar coil array AR from an end portion on a +Y direction side in the Y direction. The other is a slit that cuts into the center from an end portion on a −Y direction side.

The two slits are disposed to face each other at the same position in the X direction at an interval in the Y direction, and constitute the pair of slits 503 and 503.

However, only one of the two slits may be provided. That is, at least one of the pair of slits 503 and 503 is provided.

The slits 503 are provided at an intermediate position between the two slits 501 and 501 in the X direction.

The slit 503 has the same effect as the slit 501. That is, by providing the slits 503, the cross-sectional area of the path of the electric signal in the magnetic shield members 403 and 405 is reduced, and the electrical resistance increases. The electrical resistance functions as a current limiting resistor that limits the return current described above. Accordingly, the return current is suppressed. As a result, the problem that the magnetic field generated by the planar coil array AR is cancelled out and weakened is alleviated.

The slit 503 is a slit extending in the Y direction orthogonal to the X direction, and similar to the slit 501, it can be said to be a slit that has a function of suppressing the return current.

It is preferable that the slits 501 and 503 are both provided, but the present invention is not limited thereto, and it can be assumed that only one of the slits 501 and 503 is provided.

When the slit 501 and the slit 503 are connected to each other, a mechanical strength of the magnetic shield members 403 and 405 is weakened, and thus the slits 501 and 503 are not connected to each other.

In this way, the magnetic shield members 403 and 405 each have a conductor pattern in which at least one of the slits 501 and 503 is provided.

In other words, the conductor patterns of the magnetic shield members 403 and 405 are conductor patterns provided with at least one of the slits 501 extending in one direction and the slits 503 extending in the direction orthogonal to the one direction, each having a function of suppressing the return current.

A-2 of FIG. 10 shows an example of a more detailed configuration of the magnetic shield member 405. The slits 503 and 503 extending in the Y direction constitute a pair of slits G1.

Further, the plurality of slits 501 extending in the X direction are provided to form a slit group G2. The plurality of slits 501 are arranged parallel to each other at predetermined intervals in the Y direction. By providing the slit group G2, the return current can be more effectively suppressed.

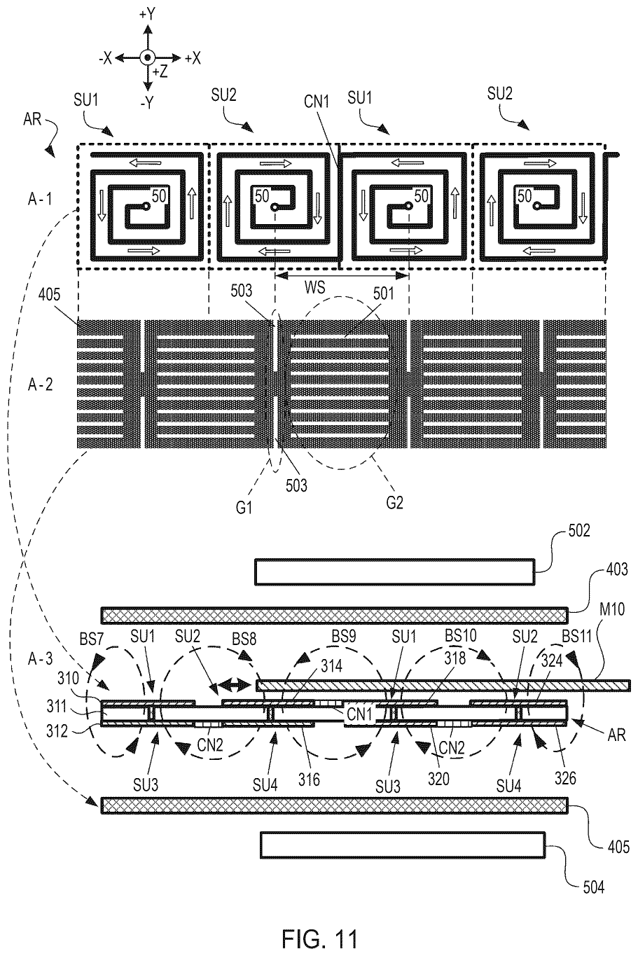

Next, FIG. 11 will be referred to. FIG. 11 is a view showing a relative positional relationship between the shield members and the planar coil array shown in FIG. 10.

A-1 of FIG. 11 is a plan view of the planar coil array using the four planar coils previously described in FIG. 1. Since an electrical connection relationship between the planar coils is as shown in FIG. 1, it is omitted in A-1 of FIG. 11.

The magnetic shield member 405 previously described with reference to A-2 of FIG. 10 is drawn in A-2 of FIG. 11. As shown in A-2 of FIG. 11, the slit group G2 having a plurality of slits is provided so as to correspond to an adjacent region of the two adjacent planar coils SU2 and SU1 in the planar coil array. Here, the adjacent region is a region between the center 50 of the planar coil SU2 and the center 50 of the planar coil SU1. In A-1 of FIG. 11, a range indicated by a reference numeral WS corresponds to the adjacent region. The adjacent region may be referred to as an adjacent part or an adjacent portion.

The term “adjacent region” may refer to a region of the planar coil array, or may refer to a region corresponding to the region in the magnetic shield member.

As described above, in the adjacent region of the two adjacent planar coils SU2 and SU1, a strong magnetic field is generated by combining a plurality of magnetic fields in the same direction. A large return current may be generated due to the strong magnetic field. Thus, the slit group G2 having a plurality of slits is disposed corresponding to the adjacent region. In other words, the slit group G2 is disposed so as to vertically overlap the adjacent region. Accordingly, the return current can be effectively suppressed.

The pair of slits G1 are provided so as to correspond to the position of each center 50 of the planar coils SU2 and SU1 in the X direction.

Since the planar coil array AR extends long in one direction, the adjacent region of two adjacent planar coils is often continuous along one direction. In this case, slits 503 are provided in each adjacent region of the magnetic shield member 405 in a direction orthogonal to one direction, and the return current generated in one adjacent region is suppressed from flowing into the next adjacent region with the remaining current amount. Accordingly, the return current can be effectively suppressed.

In this way, the return current generated in one adjacent region is suppressed from flowing to the next adjacent region by the pair of slits G1. Further, in one adjacent region, the current amount of return current generated in the adjacent region is reduced by the slit group G2. Accordingly, the return current can be effectively suppressed, and the problem that the magnetic field of the planar coil is cancelled out can be solved.

The magnetic shield member 405 shown in A-2 of FIG. 11 is a new multifunctional magnetic shield member having a function as a magnetic shield, a function as a yoke, and a current limiting function of limiting a current amount of a current flowing in one direction. Each function is obtained by disposing the magnetic shield member 405 close to the planar coil array AR in an appropriate relative positional relationship.

In other words, the new magnetic shield structure is implemented by the configuration related to the shape of the conductor pattern provided with the slits in the magnetic shield member 405 and the layout configuration with respect to the planar coil array AR.

The structure shown in FIG. 7 is shown again in A-3 of FIG. 11. However, the magnetic shield members are denoted by the reference numerals 402 and 404 in FIG. 7, and are denoted by the reference numerals 403 and 405 in A-3 of FIG. 11. Since the structure is described above, the description of the structure is omitted here.

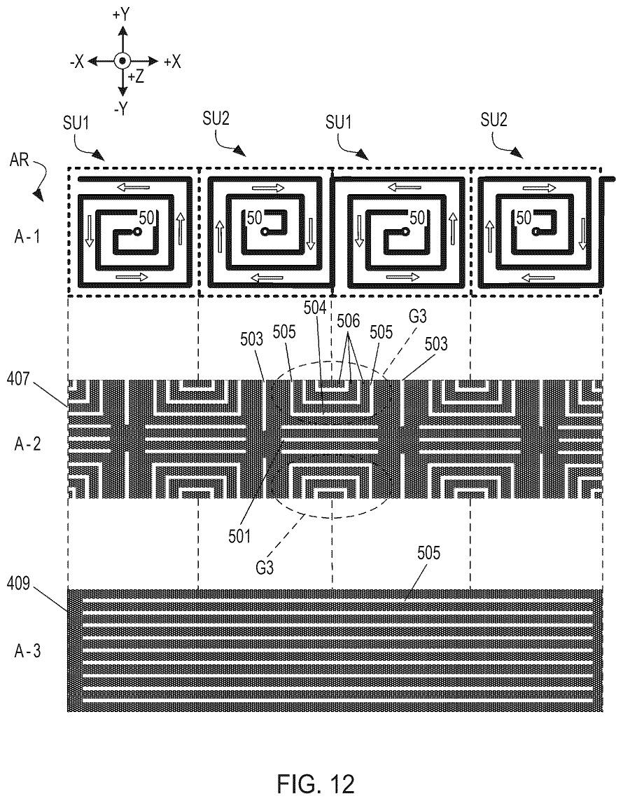

Next, FIG. 12 will be referred to. FIG. 12 is a diagram showing another configuration example of the magnetic shield members. A-1 of FIG. 12 is the same as A-1 of FIG. 11.

In A-2 of FIG. 12, slit groups G3 are provided in a magnetic shield member 407 in addition to the slits 501 and 503 described above.

When A-2 of FIG. 12 is compared with A-2 of FIG. 11 described above, three on the +Y side and three on the −Y side of the nine first slits 501 provided in the slit group G2 in A-2 of FIG. 11 are replaced with the slit group G2. Three slits 501 are arranged in a central region between the slit groups G3 and G3.

The slit group G3 includes a slit including the bent portion. The slit including the bent portion includes a first slit portion 504 extending in the X direction, and a pair of second slit portions 505 and 505 connected to both end portions, in other words, a left end portion and a right end portion, of the first slit portion 504, and extending in the Y direction orthogonal to the X direction.

When the slit 501 described above is a first slit, the slit 502 is a second slit, and the slit including the bent portion is a third slit, the magnetic shield member 407 of A-2 of FIG. 12 can be referred to as a magnetic shield member having three types of slits having different patterns.

An advantage of using the third slit having the bent portion, in other words, the third slit having the bent-shaped pattern is that the advance of the return current that flows along the X direction is blocked by the second slit portions 505 and 505 extending in the Y direction, and thus the resistance value of the electrical resistance in the X direction increases and the current limiting function is strengthened.

When attention is focused only on the strengthening of the current limiting function, the same effect can be obtained even if one large slit having a large width in the X direction is provided. However, in this case, since there is no conductive material in the portion of the large slit, a magnetic shielding effect or an effect of the yoke does not occur. Therefore, both a magnetic shielding effect of the magnetic shield members and an effect of enhancing the magnetic field by the yoke are reduced.

On the other hand, when the third slit including the bent portion is used, a pattern 506 of a conductive material is present in the slit group G3, and the magnetic shielding effect or the effect as the yoke is obtained in the pattern 506 of the conductive material. Accordingly, it is possible to strengthen the current limiting function while maintaining the magnetic shielding effect and the effect of enhancing the magnetic field by the yoke to some degree.

A-3 of FIG. 12 shows another example of the slit pattern. In a magnetic shield member 409 shown in A-3 of FIG. 12, the slit 505 which is long in the horizontal direction and extends from the vicinity of one end portion in the X direction, that is, the vicinity of a left end portion to the vicinity of the other end portion, that is, the vicinity of a right end portion is provided.

The configuration of A-3 of FIG. 12 can be regarded as a configuration in which the slits 503 in the configuration of A-2 of FIG. 11 described above are removed and the slits 501 that are dispersed along the X direction are connected to form one slit.

In other words, the slit 505 shown in A-3 of FIG. 12 can be regarded as a configuration in which the slit 501 described above extends long in the horizontal direction from the vicinity of one end portion of the magnetic shield member to the vicinity of the other end portion of the magnetic shield member. From this viewpoint, the slit 505 can be regarded as a modification of the first slit 501 obtained by changing the length of the first slit 501.

In the example of A-3 of FIG. 12, since the plurality of slits 505 long in the horizontal direction are provided, a cross-sectional area of a path of an electric signal in the magnetic shield member 409 can be effectively reduced. Accordingly, the current limiting function can be efficiently strengthened only by a simple linear slit.

As described above, according to the present embodiment, it is possible to provide the magnetic shield structure of the planar coil array in which the magnetic field generated by the planar coil array can be shielded, and the strength of the magnetic field generated by each coil constituting the planar coil array can be suppressed with the simple configuration.

### Embodiment 4

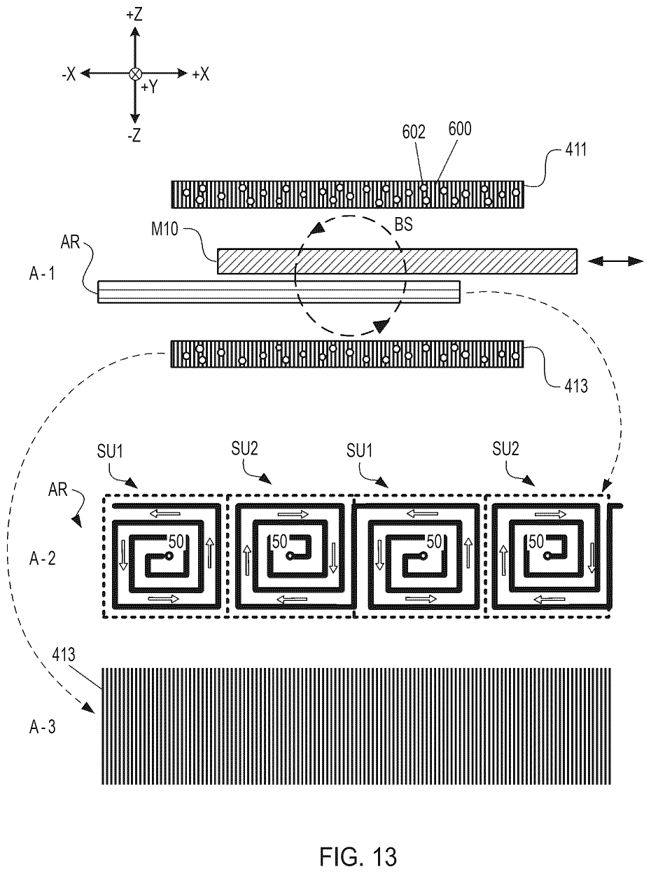

FIG. 13 is referred to. FIG. 13 is a diagram showing still another configuration example of the magnetic shield members. In the present embodiment, an example of using a magnetic resin compound obtained by mixing or kneading a powder of magnetic material with an electrically insulating resin material as the magnetic shield member will be described.

As shown in A-1 of FIG. 13, the movable conductor M10 is disposed adjacent to the planar coil array AR. Flat plate-shaped magnetic shield members 411 and 413 using the magnetic resin compound are respectively provided above and below the movable conductor M10. Both the magnetic shield members 411 and 413 are preferably provided, and any one of the magnetic shield members 411 and 413 may be provided.

A-2 of FIG. 13 is the same as A-1 of FIG. 12. A-3 of FIG. 13 shows a shape of the magnetic shield member 413 in a plan view. As shown in FIG. 13, the magnetic shield member 413 has a rectangular shape in the plan view extending along the X direction which is the same as an extending direction of the planar coil array AR.

As described above, the magnetic shield members 411 and 413 are formed by mixing or kneading the powder of the magnetic material with the electrical insulating material.

For example, an epoxy resin or a polyamide resin may be used as the electrical insulating material. As the powder of the magnetic material, for example, a ferromagnetic powder can be used.

A ferromagnetic material is a substance that is more strongly magnetized in a magnetic field and remains magnetized even when a magnetic field is removed. For example, iron, cobalt, nickel, alloys thereof, and ferrite are known. The ferrite is a magnetic oxide containing iron oxide as a main component. In addition to high magnetic permeability and high electrical resistance, it is also characterized by not producing eddy currents. In consideration of this point, the ferrite can be said to be one of the ferromagnetic materials used in the present embodiment. However, the materials described above are examples, and the present invention is not limited thereto.

The magnetic resin compound can be produced, for example, by molding a resin obtained by mixing or kneading a magnetic powder into a desired shape by injection molding, and then firing the resin at a high temperature.

Since the magnetic shield members 411 and 413 are formed by mixing or kneading the ferromagnetic powder with the resin, the ferromagnetic powder is magnetized under the influence of the magnetic field BS generated by the planar coil array AR. Accordingly, leakage of the magnetic flux to the outside through the resin as a base material is suppressed. By appropriately adjusting the concentration of the ferromagnetic powder, a necessary magnetic shielding effect can be obtained.

Further, when the ferromagnetic powder is magnetized by the influence of the magnetic field BS generated by the planar coil array AR, the ferromagnetic powder has a function of increasing the magnetic flux density, thereby causing a function as a yoke. That is, as described above, the magnetic shield members 411 and 413 function as yokes that couple the magnetic fluxes of the two adjacent planar coils in the planar coil array AR.

On the other hand, since the base material of the magnetic shield members 411 and 413 is an insulating resin, the eddy current does not flow on the front surfaces of the magnetic shield members 411 and 413 due to the influence of the magnetic field BS generated by the planar coil array AR. Accordingly, the return current described above does not occur, and the problem of cancelling out the magnetic field of the planar coil array AR is eliminated.

Accordingly, the magnetic shield members 411 and 413 serve as multifunctional magnetic shield members having the magnetic shielding effect, an effect of improving the magnetic flux density as the yoke, and an effect of preventing a current that generates the magnetic field that cancels out the magnetic field of the planar coil array.

In this way, according to the present embodiment, it is possible to provide the magnetic shield structure of the planar coil array in which the magnetic field generated by the planar coil array can be shielded, and the strength of the magnetic field generated by each coil constituting the planar coil array can be suppressed with the simple configuration.

### Embodiment 5

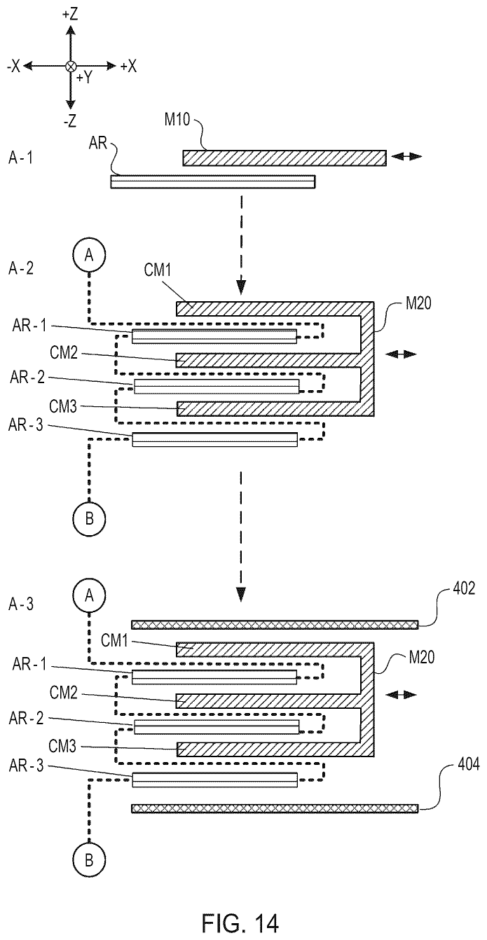

Next, FIG. 14 will be referred to. FIG. 14 is a diagram showing a configuration using a comb-tooth-shaped movable conductor and a plurality of planar coil arrays.

As shown in A-1 of FIG. 14, when the planar coil array is applied to a displacement sensor, the movable conductor M10 is disposed in the vicinity of the planar coil array AR.

In A-2 of FIG. 14, a comb-tooth electrode is used as a movable conductor. In other words, a comb-tooth-shaped movable conductor M20 is used. The comb-tooth-shaped movable conductor M20 has comb-tooth members CM1 to CM3.

Further, a plurality of planar coil arrays AR-1 to AR-3 are provided. The planar coil arrays AR-1 to AR-3 extend parallel to each other along the X direction, which is a predetermined direction, and are stacked at intervals in the Y direction orthogonal to the X direction.

Here, the interval is not limited to the magnitude thereof, and may be an object with an insulator interposed therebetween as long as insulation is ensured.

As the insulator, for example, a barium titanate-based dielectric ceramic material may be used.

Each of the planar coil arrays AR-1 to AR-3 includes the same number of planar coils. It is preferable that the planar coil arrays AR-1 to AR-3 are arranged such that the spirals of the planar coils included in the planar coil arrays are overlapped with each other and directions of the currents flowing through the spirals are the same in a plan view viewed from the Y direction.

The planar coil array AR-1 is disposed between the comb-tooth members CM1 and CM2, and the planar coil array AR-2 is disposed between the comb-tooth members CM2 and CM3. The planar coil array AR-3 is disposed below the comb-tooth member CM3.

In other words, the planar coil arrays AR1 and AR2 are arranged to sandwich the comb-tooth member CM2, and the planar coil arrays AR2 and AR3 are arranged to sandwich the comb-tooth member CM3.

The planar coil arrays AR1 to AR3 are electrically connected by a signal line indicated by a broken line. In other words, the planar coil arrays AR1 to AR3 are connected in series between the terminals A and B.

According to this configuration, when the movable conductor M20 is displaced, a variation in the inductance occurs in each planar coil array, and the characteristics of the electric signal change in the same manner. Accordingly, the change in the electrical characteristics is emphasized. Accordingly, the detection sensitivity of the displacement sensor can be further improved.

In A-3 of FIG. 14, the magnetic shield member 402 is disposed on the +Y side of, that is, above the planar coil arrays AR1 to AR3 and the comb-tooth-shaped movable conductor M20. The magnetic shield member 404 is disposed on the −Y side of, that is, below the planar coil arrays AR1 to AR3 and the comb-tooth-shaped movable conductor M20. In other words, the magnetic shield members 402 and 404 are arranged parallel to each other so as to sandwich the planar coil arrays AR1 to AR3 and the comb-tooth-shaped movable conductor M20 in the upper-lower direction.

As the magnetic shield members 402 and 404, the magnetic shield member shown in any one of FIGS. 10 to 13 can be used. The magnetic shield members 402 and 404 constitute a magnetic shield structure for the planar coil arrays AR1 to AR3.

However, if the magnetic shield members 402 and 404 are regarded as accessories which are subordinate to the planar coil arrays AR1 to AR3 from a different point of view, it can also be said that the planar coil array with the magnetic shield members is constructed.

Both the magnetic shield members 402 and 404 are preferably used, and any one of the magnetic shield members 402 and 404 may be used. In this case, since there is no comb-tooth member below the planar coil array AR3, that is, on a back surface of the planar coil, the magnetic field of the coil easily leaks. Accordingly, it is preferable to preferentially provide the magnetic shield member 404.

As described above, there are the plurality of planar coil arrays AR-1 to AR-3 of the present invention, and each of the planar coil arrays AR-1 to AR-3 extends parallel to each other along the predetermined direction. One planar coil array may be formed by stacking the planar coil arrays at intervals in a direction orthogonal to the predetermined direction and electrically connecting the planar coil arrays.

According to this configuration, when the movable conductor is displaced, a variation in the inductance occurs in each planar coil array, and the characteristics of the electric signal change in the same manner. Accordingly, the change in the electrical characteristics is emphasized. Accordingly, the detection sensitivity of the displacement sensor can be further improved.

### Embodiment 6

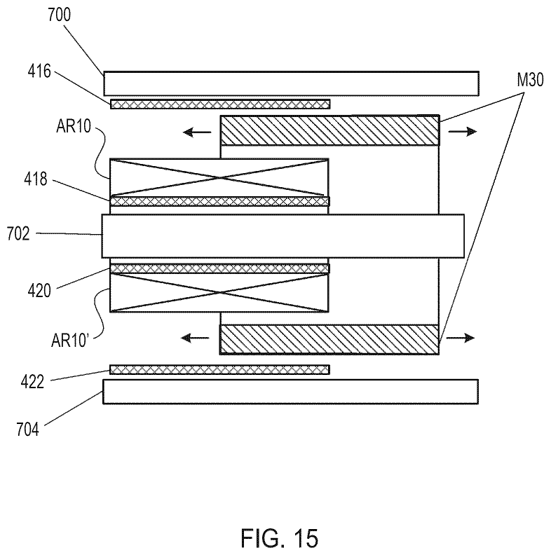

Next, FIG. 15 will be referred to. FIG. 15 is a diagram showing an arrangement example of magnetic shield members. In FIG. 15, planar coil arrays AR10, 10′ and a peripheral conductor 702 are disposed inside a cylindrical movable conductor tube M30. Peripheral conductors 700 and 704 are disposed outside the movable conductor tube M30.

A magnetic shield member 416 is provided between the movable conductor tube M20 and the peripheral conductor 700 located outside the movable conductor tube M20.

The magnetic shield member 418 is provided between the planar coil array AR10 and the peripheral conductor 702 located inside the movable conductor tube M30.

The magnetic shield member 420 is provided between the planar coil array AR10′ and the peripheral conductor 702 located inside the movable conductor tube M30.

The magnetic shield member 416 is provided between the movable conductor tube M20 and the peripheral conductor 704 located outside the movable conductor tube M20.

No magnetic shield member is provided on fitting surfaces of the movable conductor tube M30 and the planar coil arrays AR10 and AR10′. In some cases, current flows through the peripheral conductors 700, 702, and 704 due to the influence of the magnetic field generated by the planar coil arrays AR10 and AR10′ to cause noise. Accordingly, the magnetic shield members 416, 418, and 422 are disposed between each of the peripheral conductors 700, 702, and 704 and the planar coil arrays AR10 and AR10′ to suppress noise generation.

As the magnetic shield members 416, 418, and 422, the magnetic shield member shown in any one of FIGS. 10 to 13 can be used. The magnetic shield members 416, 418, and 422 constitute a magnetic shield structure for the planar coil arrays AR1 to AR3. As the magnetic shield member, a three-dimensional shape obtained by bending the planar coil array may be used. This point will be described later.

### Embodiment 7

In the present embodiment, a planar coil array having a three-dimensional shape will be described. When a coil in the related art having a three-dimensional shape is replaced with a flat-plate-shaped planar coil array, a layout may be difficult. In consideration of this point, in the present embodiment, an example in which a flexible printed board, a flexible film-shaped board, or the like is used and bent to form the desired three-dimensional shape will be described.

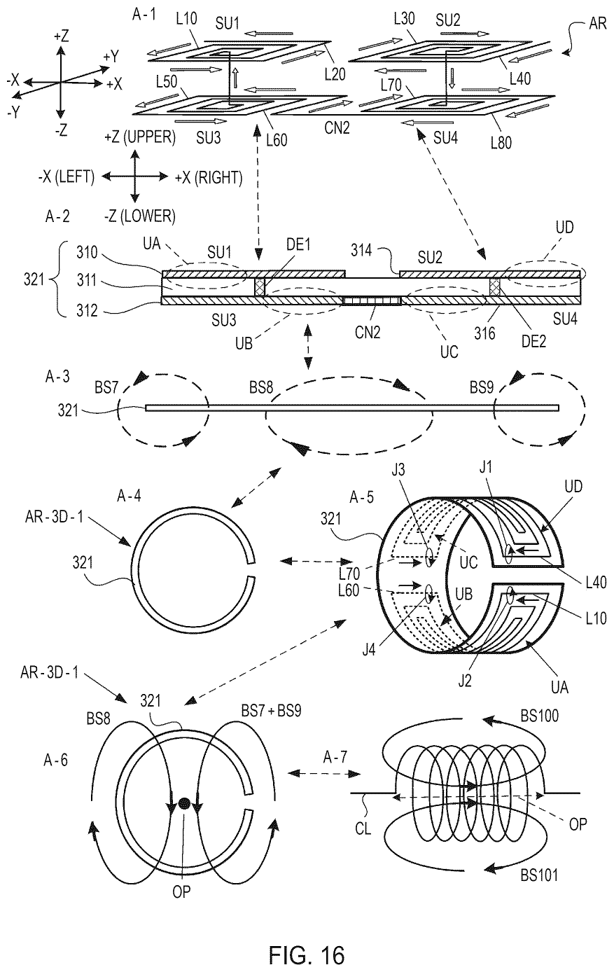

FIG. 16 is referred to. FIG. 16 is a diagram showing a structure example of a planar coil array having a three-dimensional shape and a direction of a generated magnetic field. In FIG. 16, the same portions as those in the above-described drawings are denoted by the same reference numerals. In the following description, an example using the flexible printed board will be described.

A-1 of FIG. 16 shows the planar coil array AR having the multilayer structure previously shown in FIG. 5. A cross-sectional structure of the planar coil array AR shown in A-1 is shown in A-2 of FIG. 16. This cross-sectional structure is the same as that shown on the left side of FIG. 6A.

However, the present invention is not limited to the multilayer structure, and for example, a planar coil array in which planar coils on the same layer shown in FIG. 4 are arranged side by side may be used.

As described above, the planar coil SU1 has a spiral shape in which the conductor 310 on an upper layer is wound around the center in a left-handed manner.

The planar coil SU2 is disposed adjacent to the first planar coil SU1 in the X direction. The second planar coil SU2 has a spiral shape in which the conductor 314 on the same layer as the conductor of the planar coil SU1 is wound around the center in the same manner as the first planar coil, in other words, in the same direction as the first planar coil, and has an angular deviation from the first spiral shape, that is, in a preferable example, a deviation of 180 degrees. In other words, the planar coils SU1 and SU2 have a relative positional relationship in which when one spiral is rotated to the left direction or the right direction by 180 degrees, the one spiral overlaps with the other spiral.

The left-handed planar coils SU1 and SU2 constitute a planar coil on the upper layer.

The planar coils SU3 and SU4 on the lower surface are stacked on the planar coils SU1 and SU2 on the upper surface, respectively, so as to overlap each other in the plan view. The planar coils SU3 and SU4 on the lower layer are right-handed planar coils, and the planar coils SU1 and SU2 on the upper layer are wound in opposite directions, that is, opposite spiral winding directions In other words, the planar coils SU1 and SU3 have a relative positional relationship in which when one spiral is reversed horizontally, the one spiral overlaps the other spiral. The same applies to the planar coils SU2 and SU4.

The spirals of the planar coils SU2 and SU4 on the lower layer are deviated by 180 degrees from each other.

A center of the planar coil SU1 and a center of the planar coil SU3 are electrically connected by the center connection conductor DE1, and the center of the planar coil SU2 and the center of the planar coil SU4 are electrically connected by the center connection conductor DE2.

End portions of the planar coils SU3 and SU4 on the lower layer are electrically connected to each other by the end portion connection conductor CN2.

Accordingly, the center of the planar coil SU1 and the center of the planar coil unit SU2 are electrically connected to each other via a path including the center connection conductor DE1, the planar coil SU3, the end portion connection conductor CN2, the planar coil SU4, and the center connection conductor DE2.

Here, the planar coils SU3 and SU4 on the lower layer are not limited to coil elements, but may be regarded as components of an electrical path. That is, the end portions of the planar coils SU3 and SU4 on the lower layer are also components of the electrical path connecting the end portions of the planar coils SU1 and SU2 on the upper layer to each other.

In consideration of this point, the configuration of A-1 of FIG. 16 can be said to be a configuration in which the end portions of the first and second planar coils SU1 and SU2 are electrically connected to each other by the electrical path including the planar coils SU3 and SU4 on the lower layer when the planar coils SU1 and SU2 on the upper layer are the first and second planar coils in order from the left.

In the present embodiment, the flexible printed board having flexibility and capable of bending is used as the printed board 311.

As shown in A-2 of FIG. 16, the multilayer structure including the flexible printed board 311, the conductors 310 and 314 formed on a front surface thereof, the conductors 314 and 316 formed on a back surface thereof, the center connection conductors DE1 and DE2, and the end portion connection conductor CN2, that is, the planar coil array structure is denoted by reference numeral 321, and in the following description, the entire planar coil array structure is referred to as a flexible board 321. That is, the flexible board 321 includes the flexible board or base material 311, and the wiring or conductor patterns 310 to 316, DE1, DE2 formed of a conductor formed on the front surface, the back surface, or inside thereof.

In A-2 of FIG. 16, there is a region to which reference numerals UA, UB, UC, and UD are assigned. Each region is surrounded by a broken-line ellipse. Each region forms a part of the coil, and specifically is a region in which a winding pattern constituting the coil is present. In the following description, the regions UA to UD are referred to as coil regions or coil pattern regions.

As shown in A-3 of FIG. 16, the flexible board 321 generates the leftward magnetic field BS7, the rightward magnetic field BS8, and the leftward magnetic field BS9. Since this point is described with reference to FIG. 6B, detailed description thereof will be omitted.

As shown in A-4 of FIG. 16, the flexible board 321 is bent, and thus a coil having a three-dimensional shape is formed. Specifically, the three-dimensional shape is a cylindrical shape.

As shown in A-1 to A-3 of FIG. 16, the flat-plate-shaped planar coil array AR is also the flexible board 321 extending along the X direction, which is a predetermined direction, that is, along a horizontal direction.

The flexible board 321 has an end portion in the −X side, that is, a left end portion and an end portion in the +X side, that is, a right end portion. The left end portion can be referred to as one end portion in the X direction, which is the predetermined direction, and the right end portion can be referred to as the other end portion.

As shown in A-4 and A-5 of FIG. 16, the flexible board 321 is bent such that the one end portion and the other end portion of the flexible board 321 in the X direction, which is the predetermined direction, are close to each other or are in contact with each other, thereby forming the cylindrical three-dimensional shape.

In the examples of A-4 and A-5 in FIG. 16, the end portions are close to each other, but are located slightly away from each other. The end portions may be brought into contact with each other, and a cross-sectional shape thereof may be a circle or an ellipse.

As shown in A-4 of FIG. 16, the planar coil array having the three-dimensional shape subjected to bending is denoted by a reference numeral AR-3D-1. If simply written as the planar coil array AR, it cannot be distinguished from a flat-plate-shaped coil array, so the one having the three-dimensional shape will be referred to as AR-3D. A numeral 1 at the end indicates a first example of the AR-3D.

As shown in A-5 of FIG. 16, a pair of wirings L40 and L10 and L70 and L60 disposed close to each other extend in the same direction in the three-dimensional space.

Here, currents flow in the same direction in the pair of wirings L40 and L10. Accordingly, magnetic fields J1 and J2 in the same direction are generated here.

On the other hand, currents flow in the same direction in the pair of wirings L70 and L60, but the direction is opposite to the direction of the currents in the wirings L40 and L10. Accordingly, the magnetic fields J3 and J4 become rightward magnetic fields.

Since the directions of the magnetic fields J1 and J2 are the same, the magnetic fields J1 and J2 do not cancel out each other and thus a strong magnetic field can be generated. The same applies to the magnetic fields J3 and J4.

Here, the wiring L40 is a wiring included in the coil pattern region UD, and is a linear wiring at an endmost portion located at a position closest to the one end portion of the flexible board 321.

The wiring L10 is a wiring included in the coil pattern region UA and is a linear wiring at an endmost portion located at a position closest to the other end portion of the flexible board 321.

The wiring L70 is a wiring included in the coil pattern region UC, and is a straight wiring located on a side opposite to the wiring L40 in the X direction, which is the predetermined direction, and extending parallel to the wiring L40.

Further, the wiring L80 is a wiring included in the coil pattern region UB, and is a linear wiring located on a side opposite to the wiring L10 in the X direction, which is the predetermined direction, and extending parallel to the wiring L10.

As shown in A-6 of FIG. 16, a magnetic field obtained by combining the magnetic field BS8 previously shown in A-3 with the magnetic fields BS7 and BS9 is generated in the planar coil array AR-3D-1 formed of the cylindrical flexible board 321. The magnetic field BS8 is a rightward magnetic field, and a magnetic field obtained by combining the magnetic fields BS7 and BS9 is a leftward magnetic field. The strength of each magnetic field is the same, and a strong magnetic field balanced in the left and right with respect to an axis for bending OP is generated. The axis for bending OP may be referred to as a central axis of the coil. Note that the axis for bending OP is a straight line extending from a front side of a paper surface to a back side of the paper surface.

As shown in A-6 of FIG. 16, each magnetic field line of the magnetic field obtained by combining the magnetic field BS8 with the magnetic fields BS7 and BS9 is orthogonal to the axis for bending OP. In other words, when the magnetic field lines intersect the axis for bending OP, the magnetic field lines cross the axis for bending OP from the top to the bottom at an angle of 90 degrees.

Here, “orthogonal” is not limited only to 90 degrees, and can be functionally satisfied as long as it is substantially orthogonal, and thus “orthogonal” is not strictly limited.

A horizontally long coil CL in the related art is shown in A-7 of FIG. 16. Magnetic fields BS100 and BS101 generated by the coil CL in the related art are magnetic fields parallel to the central axis OP of the coil.

As described above, a direction of the magnetic field generated by the planar coil array AR-3D-1 shown in A-6 of FIG. 16 with respect to an axis for bending, that is, the central axis OP of the coil is different from that of an example in the related art shown in A-7. This point can be referred to as one feature of the planar coil array AR-3D-1 as the coil.

When the planar coil array AR-3D-1 of FIG. 16 has a flat shape, the electrical connection of the planar coils is already completed. Thus, the flexible board 321 can be manufactured only by bending. Accordingly, it is possible to provide the coil having the three-dimensional shape using the planar coil array which can be manufactured inexpensively and easily.

In the planar coil array AR-3D-1, as shown in A-6 of FIG. 16, the strong magnetic field with good balance can be generated on the left and right with respect to the axis for bending OP.

Accordingly, for example, when the planar coil array AR-3D-1 is applied to a displacement sensor such as a stroke sensor, a displacement sensor having a low noise, a high detection sensitivity, in other words, a high gain is implemented.

Further, since the planar coil array AR-3D-1 has a cylindrical shape similar to the horizontally long coil in the related art, the planar coil array AR-3D-1 can be easily disposed near the movable conductor tube.

Further, the planar coil array AR-3D-1 can be manufactured by bending a planar coil array AR50 having a simplified configuration, and can have a compact shape as a whole. Therefore, an effect that the planar coil array AR-3D-1 can be easily disposed in a narrow space is also obtained.

### Embodiment 8

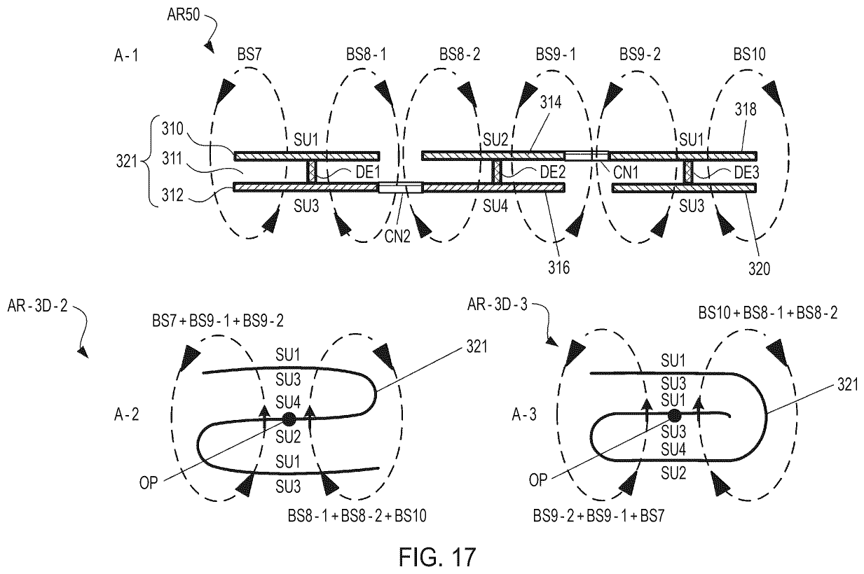

Next, FIG. 17 will be referred to. FIG. 17 is a diagram showing another structure example of the planar coil array having the three-dimensional shape and the direction of the generated magnetic field.

In the planar coil array AR50 shown in A-1 of FIG. 17, three planar coils SU1, SU2, and SU1 are used as planar coils on an upper layer. Three planar coils SU3, SU4, and SU3 are used as planar coils on a lower layer.

A configuration of A-1 of FIG. 17 is a structure in which the planar coils SU1 and SU4 located at the right end are removed from the multilayer structure previously shown in FIG. 6B. The content previously described in FIG. 6B may also be applied to a structure of A-1 of FIG. 17. Detailed description of the multilayer structure will be omitted.

Also in the configuration of A-1 of FIG. 17, the left-end planar coil SU3 and the planar coil SU4 on the right adjacent thereto on the lower layer can be regarded as components of an electrical path connecting end portions of the planar coils SU1 and SU2 on the upper layer, respectively.

Here, the planar coils on the upper layer SU1, SU2, and SU1 are referred to as first, second, and third planar coils in order from the left.

The planar coil array AR50 has a configuration in which the end portions of the first and second planar coils SU1 and SU2 are electrically connected to each other by an electrical path including the third and fourth planar coils on the lower layer, and the second planar coil SU2 and the third planar coil SU1 adjacent to the right thereof are electrically connected by the end portion connection conductor CN1 on the same layer.

Further, the magnetic field BS8 previously shown in FIG. 6B is drawn by being divided into BS8-1 and BS8-2 in A-1 of FIG. 17. Similarly, the magnetic field BS9 is divided into BS9-1 and BS9-2.

Next, A-2 of FIG. 17 will be referred to. As shown, a planar coil array AR-3D-2 has a wavy three-dimensional shape. Focusing on the first, second, and third planar coils SU1, SU2, and SU1 on the upper layer, each planar coil is folded back, and the planar coils SU1, SU2, and SU3 are stacked in the Y direction orthogonal to the X direction, that is, the upper-lower direction, which is a predetermined direction, to form the wavy cross-sectional structure.

When the viewing direction is changed, the wavy three-dimensional shape of the planar coil array AR-3D-2 has a three-dimensional shape in which the first, second, and third planar coils SU1, SU2, and SU1 on the upper layer overlap each other in a plan view as viewed from the Y direction.

Considering the planar coils SU3, SU4, and SU3 on the lower layer, the planar coil array AR-3D-2 has the wavy three-dimensional shape in which the planar coil arrays SU1, SU3, SU4, SU2, SU1, and SU3 are stacked in this order from the top.

In the planar coil array AR-3D-2, a strong magnetic field with good balance is generated on the left and right with respect to the axis for bending OP. A left-side magnetic field is a leftward magnetic field generated by combining the magnetic fields BS7, BS9-1, and BS9-2. A right-side magnetic field is a rightward magnetic field generated by combining the magnetic fields BS8-1, BS8-2, and BS10.

Next, A-3 of FIG. 17 will be referred to. As shown in A-3 of FIG. 17, a planar coil array AR-3D-3 has a roll-shaped three-dimensional shape in which the planar coil array AR50 is wound in a roll shape.

When focusing on the first, second, and third planar coils SU1, SU2, and SU1 on the upper layer, the planar coil array AR50 has a roll-shaped cross-sectional structure in which the planar coils SU1, SU2, and SU1 are stacked in the Y direction, that is, in the upper-lower direction.

When the viewing direction is changed, the roll-shaped three-dimensional shape of the planar coil array AR-3D-3 can be referred to as a three-dimensional shape in which the first, second, and third planar coils SU1, SU2, and SU1 on the upper layer overlap each other in the plan view as viewed from the Y direction. This point is common to the wavy three-dimensional shape indicated by A-2.

In consideration of the planar coils SU3, SU4, and SU3 on the lower layer, the planar coil array AR-3D-3 has the roll-shaped three-dimensional shape in which the planar coil arrays SU1, SU3, SU1, SU3, SU4, and SU2 are stacked in this order from the top.

In the planar coil array AR-3D-3, a strong magnetic field with good balance is generated on the left and right with respect to the axis for bending OP. A left-side magnetic field is a leftward magnetic field generated by combining the magnetic fields BS9-2, BS9-1, and BS7. A right-side magnetic field is a rightward magnetic field generated by combining the magnetic fields BS10, BS8-1, and BS8-2.

The planar coil array AR-3D-2 and the planar coil array AR-3D-3 of FIG. 17 each have a flat shape, the electrical connection of the planar coils is already completed. Thus, the flexible board 321 can be manufactured only by bending. Accordingly, it is possible to provide the coil having the three-dimensional shape using the planar coil array which can be manufactured inexpensively and easily.

In the planar coil array AR-3D-2 and the planar coil array AR-3D-3, as shown in A-2 and A-3 of FIG. 17, the strong magnetic field with good balance can be generated on the left and right with respect to the axis for bending OP.

Accordingly, for example, when the planar coil arrays AR-3D-2 and AR-3D-3 are applied to a displacement sensor such as a stroke sensor, a displacement sensor having a low noise, a high detection sensitivity, in other words, a high gain is implemented.

Further, since the planar coil arrays AR-3D-2 and AR-3D-3 have a small structure in which planar coils are stacked in a plan view, an effect that the planar coil arrays AR-3D-2 and AR-3D-3 can be easily disposed in a narrow space is also obtained.

### Embodiment 9

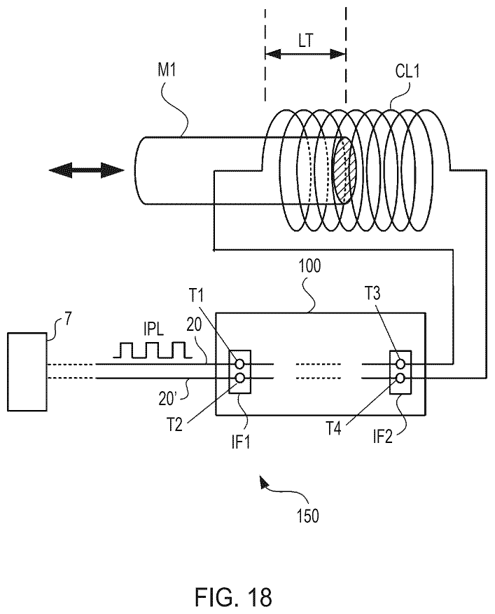

Next, the displacement sensor will be described. FIG. 18 is a diagram showing a detection principle of the displacement sensor. A stroke sensor 150 as the displacement sensor includes the coil CL1 that is fitted with the movable conductor M1 with a fitting length LT and whose inductance changes according to a displacement amount of the movable conductor M1, a sensor body 100, and a detection unit 7. The coil CL1 may be referred to as a resonance coil.

The sensor body 100 includes interface circuits IF1 and IF2. The interface circuit IF1 includes two terminals T1 and T2. A wire harness 20 that transmits a current pulse signal IPL is connected to the terminal T1, and a grounded wire harness 20′, for example, is connected to the terminal T2.

The interface circuit IF2 includes two terminals T3 and T4. One end of the coil CL1 is connected to the terminal T3, and the other end of the coil CL1 is connected to the terminal T4.

When the movable conductor M1 is displaced, the fitting length LT is changed, and accordingly, the frequency of the current pulse signal IPL changes. The detection unit 7 can detect the displacement amount of the movable conductor M1 by detecting a change in the frequency of the current pulse signal IPL.

The term “frequency” can be rephrased as electrical characteristics of an electric signal in a broad sense.

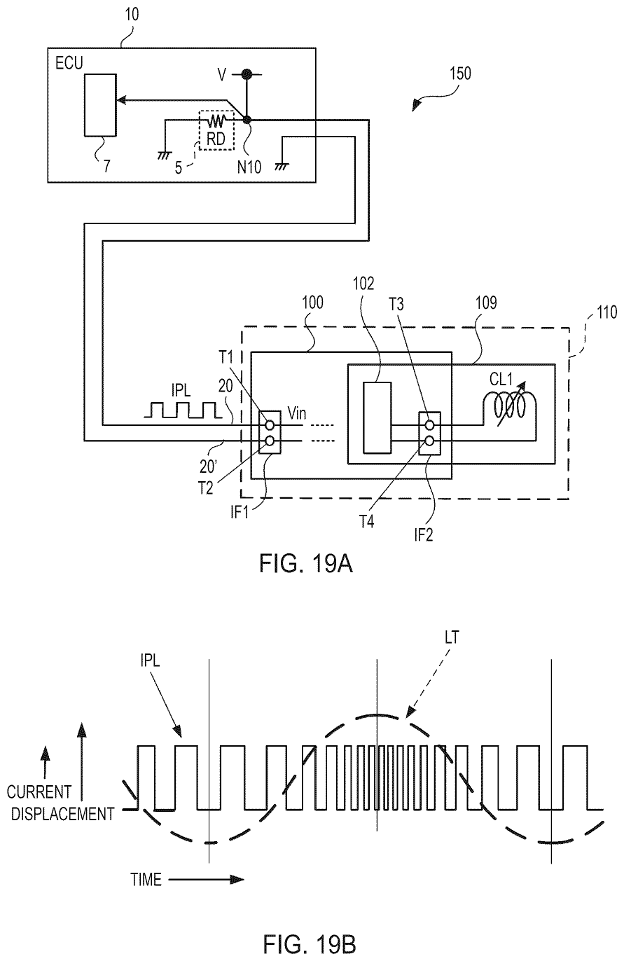

Next, FIG. 19A will be referred to. FIG. 19A is a diagram showing an example of a specific configuration of the displacement sensor. In FIG. 19A, portions common to those in FIG. 18 are denoted by the same reference numerals.

In FIG. 19A, an oscillation circuit 102 that generates the current pulse signal IPL is provided inside the sensor body 100.

A resistor RD whose one end is connected to a power supply potential V is provided inside the ECU 10. The resistor RD functions as a current and voltage converter 5. A voltage signal obtained from a common connection point between the power supply potential V and the resistor RD is input to the detection unit 7.

Next, FIG. 19B will be referred to. FIG. 19B is a diagram showing an example of a change in the frequency of the current pulse signal corresponding to a change in the fitting length between the movable conductor and the coil.

In FIG. 19B, the change in the fitting length LT between the movable conductor M1 and the coil CL1 is indicated by a broken line. The frequency of the current pulse signal changes according to the change in the fitting length LT. By detecting the change in the frequency, the displacement of the movable conductor M1 can be detected.

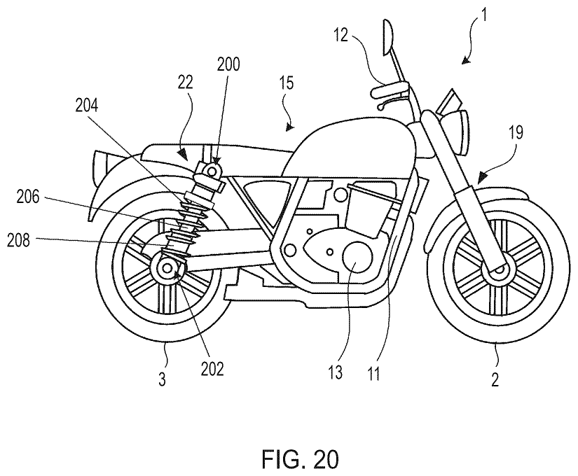

Next, FIG. 20 will be referred to. FIG. 20 is a diagram showing an example of an overall configuration of a motorcycle in which the displacement sensor of the present invention is applied to a suspension.

By applying the displacement sensor of the present invention to the suspension, a stroke sensor that detects displacement of the suspension is implemented. Examples of the suspension may include a rear suspension and a front fork.

As shown in FIG. 20, the motorcycle 1 includes a front wheel 2, a rear wheel 3, a vehicle body main body 15 including a vehicle body frame 11 that forms a framework of the motorcycle 1, a handle 12, an engine 13, or the like.

Further, the motorcycle 1 includes one front fork 19 connecting the front wheel 2 to the vehicle body main body 15 on each of a left side and a right side of the front wheel 2. Further, the motorcycle 1 includes one rear suspension 22 connecting the rear wheel 3 to the vehicle body main body 15 on each of a left side and a right side of the rear wheel 3. In FIG. 20, only the front fork 19 and the rear suspension 22 disposed on one side are shown.

The rear suspension 22 is, for example, a hydraulic suspension. FIG. 20 shows an external configuration of the rear suspension 22. The rear suspension 22 includes a vehicle-body-side attachment member 200, a wheel-side attachment member 202, a coil spring 204, an outer tube 206 and a guide tube 208 constituting a cylinder portion.

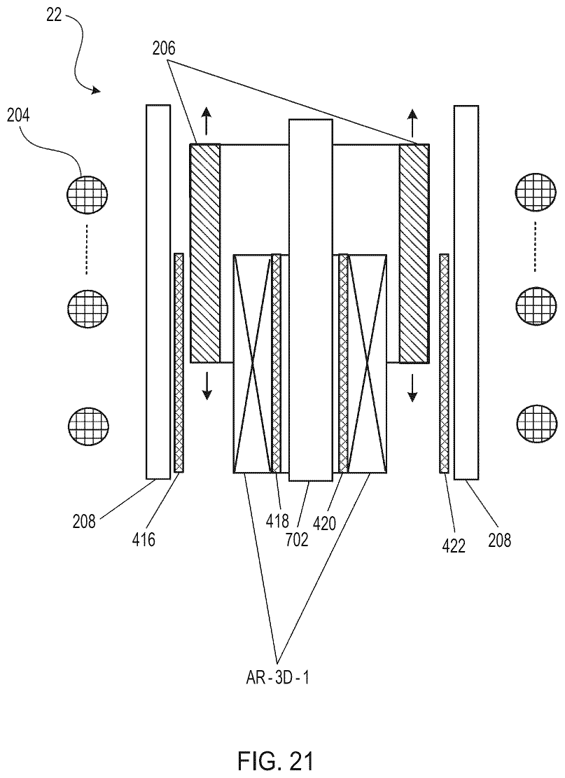

Next, FIG. 21 will be referred to. FIG. 21 is a cross-sectional view showing an example of a cross-sectional structure of the rear suspension shown in FIG. 20. In FIG. 21, the configuration previously described with reference to FIG. 15 is employed in the rear suspension 22. In FIG. 21, the same components as those in FIG. 15 are denoted by the same reference numerals. The contents described in FIG. 15 can also be applied to FIG. 21.

However, although the planar coil array AR10 is used in FIG. 15, the planar coil AR-3D-1 described in FIG. 16 is used in FIG. 21 instead of AR10.

Further, although the movable conductor tube M30 is used in FIG. 15, the outer tube 206 forming the cylinder portion is used in FIG. 21 instead of M30. In other words, the outer tube 206 functions as a movable conductor tube.

Further, although the peripheral conductors 700 and 704 are used in FIG. 15, the guide tube 208 constituting the cylinder portion is used in FIG. 21 instead of 700 and 704.

In the rear suspension 22 of FIG. 21, the guide tube 208 is disposed inside the coil spring 204, and the outer tube 206 as a movable conductor tube is disposed inside the guide tube 208. The planar coil array AR-3D-1 is disposed inside the outer tube 206.

The magnetic shield members 416 and 422 of the present invention shown in FIGS. 11 to 13 are provided between the guide tube 208 and the outer tube 206 as the movable conductor tube.

Further, the magnetic shield members 418 and 420 of the present invention shown in FIGS. 11 to 13 are provided between the planar coil array AR-3D-1 and the peripheral conductor 702 extending along the central axis of the guide tube 208.

Here, the magnetic shield members 416 and 422 can be formed of a bent common magnetic shield member. Since the planar coil array AR-3D-1 has a cylindrical shape, the magnetic shield member is also preferably bent so as to have a shape corresponding to the three-dimensional shape of the planar coil array, that is, a cylindrical cross section. The same applies to the magnetic shield members 418 and 420. This makes it possible to effectively shield the planar coil array having the three-dimensional shape by bending.

Thus, a coil component in the related art in the rear suspension 22 of the motorcycle 1 can be replaced with, for example, the planar coil array AR-3D-1 of the present invention. A flat-plate-shaped planar coil array having no three-dimensional shape may be used.

The planar coil array of the present invention is easy to manufacture, and the planar coil array is much less expensive than the coil component in the related art and can also be reduced in size. Thus, the displacement sensor that is easy to manufacture, has a simplified configuration, and is inexpensive can be obtained.

In the coil component in the related art that is long in the predetermined direction and previously shown in A-7 of FIG. 16, high cost and many man-hours are required for manufacturing the coil component. Accordingly, by using the planar coil array of the present invention instead of the coil component in the related art, the manufacturing process of the coil component can be simplified and the cost of the coil can be significantly reduced. This also contributes to reduction in cost of a vehicle such as a motorcycle.

Further, in the rear suspension of FIG. 21, the magnetic shield member is disposed at an appropriate position, and adverse influence on the peripheral conductor of the peripheral device or the like is also sufficiently reduced. Accordingly, the coil component using the planar coil array can be used in safety and security.

The above description is summarized as follows.

A displacement sensor includes the planar coil array AR according to the present invention, and the detection unit 7 that detects a change in the electrical characteristics of the electric signal, which is generated according to the displacement amount of a movable conductive object and transmitted via the planar coil array.

Accordingly, the displacement sensor that is easy to manufacture, has a simplified configuration, and is inexpensive can be obtained.

When a comb-tooth structure indicated by A-2 of FIG. 14 is employed, the planar coil array AR-1 may be disposed between the comb-tooth member CM1 and the comb-tooth member CM2 in the comb-tooth structure of the object.

Accordingly, a stronger magnetic field can be generated, and a displacement sensor having higher detection sensitivity can be implemented.

Further, the object may be a component of the suspension 22, and the displacement sensor may be the stroke sensor 150 that measures the displacement amount of the suspension by detecting electrical characteristics of an electric signal, for example, a frequency of an electric signal, or a variation in an inductance, which changes according to a relative positional relationship between the object and the planar coil array AR.

Accordingly, the stroke sensor that is easy to manufacture, has a simplified configuration, and is inexpensive can be obtained.

In the above description, the motorcycle has been described as an example, but the planar coil array of the present invention is also applicable to a three-wheeled vehicle, a four-wheeled vehicle, and the like, is also applicable to an electric automobile that is currently being developed, and the type of the vehicle is not limited.

As described above, according to the present invention, it is possible to provide the planar coil array that is simplified in configuration in which the plurality of planar coils are electrically connected and also includes a function as a low-loss path of the electric signal.

The present invention is not limited to the embodiments as long as the functions and effects of the invention are exhibited.

### INDUSTRIAL APPLICABILITY

The present invention is suitable for a planar coil array that can be used in various applications.

### REFERENCE SIGNS LIST

1 vehicle (motorcycle)
2 front wheel
3 rear wheel
5 current and voltage converter
7 detection unit
10 ECU (control unit, signal processing unit, electronic control unit)
11 vehicle body frame
12 handle
13 engine
15 vehicle body main body
19 front fork
20, 20′ connecting wire (wire harness)
22 rear suspension (shock absorber)
34 microstrip line (high-frequency transmission path)
35 current flowing along one direction in planar coil array
38, 47, 47′ current flowing through peripheral conductor (return current)
83 conductor connecting centers of adjacent planar coils (center connection conductor, wire harness having arch shape)
87 conductor connecting centers of adjacent planar coils (center connection conductor, bridge electrode, electrode having multilayer structure, and wiring having multilayer structure)
100 sensor body
102 oscillation circuit
150 stroke sensor as displacement sensor
200 vehicle-body-side attachment member
202 wheel-side attachment member
204 coil spring
206 outer tube (component of shock absorber, movable conductor (detection conductor))
208 guide tube
310, 314, 318, 324 front surface conductor of printed board (front surface wiring and upper layer wiring)
311 board or base material (printed board, rigid board, flexible printed wiring board, film-shaped flexible printed wiring board)
312, 316, 320, 326 back surface conductor of printed board (back-surface wiring and lower-layer wiring)
321 flexible board
402, 404, 416, 418, 420, 422 magnetic shield member
416, 418, 420, 422 magnetic shield member
502, 504 object to be protected, peripheral conductor, electronic board (semiconductor board or the like)
501 slit in predetermined direction
503 slit perpendicular to predetermined direction
700, 702, 704 peripheral conductor disposed inside outer tube
AR, AR1-3, AR10 planar coil array
SU1 planar coil (planar coil unit) wound in predetermined direction
SU2 planar coil (planar coil unit) having the same winding direction as SU1 and having angular deviation (deviation of 180 degrees in preferable example)
M1, M10, M20, M30 conductor to be detected (detection conductor, movable conductor)
CL, CL1 coil (sensor coil)
BS1 to BS11 direction of magnetic field (magnetic flux) generated by planar coil array
P1 to P4 wiring constituting planar coil
CN1, CN2 conductor (end portion connection wiring) connecting end portions on outer peripheral sides of adjacent planar coils
F1 to F3 component of end portion connection wiring
VIAH via hole
DE1 to DE4 via electrode (via buried conductor, interlayer connection conductor)
T1 to T4 terminal
IF1 ECU-side interface
IF2 coil-side interface
LT fitting length

1. A planar coil array comprising:
a first planar coil having a first spiral shape in which a first conductor is wound around a first center in a left-handed manner or a right-handed manner;
a second planar coil having a second spiral shape in which a second conductor on the same layer as the first conductor is wound around a second center in the same manner as the first coil and has an angular deviation from the first spiral shape, and disposed adjacent to the first planar coil in a predetermined direction; and
a first connection conductor configured to electrically connect the first and second planar coils, wherein
when a current flows from the first center toward a first end portion on a side opposite to the first center in the first planar coil, a current flows from a second end portion opposite to the second center toward the second center in the second planar coil,
when a current flows from the first end portion toward the first center in the first planar coil, a current flows from the second center toward the second end portion in the second planar coil, and
the first connection conductor electrically connects the first center of the first planar coil to the second center of the second planar coil.

2. (canceled)

3. The planar coil array according to claim 1, wherein the first connection conductor is formed by a conductor wire, a conductor electrode, or a conductor wiring having a multilayer structure, which is provided to straddle a winding of each of the first and second planar coils.

4. (canceled)

5. (canceled)

6. A planar coil array comprising:
a first planar coil having a first spiral shape in which a first conductor is wound around a first center in a left-handed manner or a right-handed manner;
a second planar coil having a second spiral shape in which a second conductor on the same layer as the first conductor is wound around a second center in the same manner as the first planar coil and has an angular deviation from the first spiral shape, and disposed to be adjacent to the first planar coil in a predetermined direction;
a first connection conductor configured to electrically connect the first and second planar coils;
a third planar coil in which a third conductor on a layer different from that of the first conductor is spirally wound around a third center in a direction opposite to that of the first planar coil, and is disposed so as to overlap the first planar coil in a plan view;
a fourth planar coil in which a fourth conductor on the same layer as the third conductor is spirally wound around a fourth center in a direction opposite to that of the second planar coil, and is disposed so as to overlap the second planar coil in the plan view;
a second connection conductor configured to electrically connect the first center of the first planar coil to the third center of the third planar coil;
a third connection conductor configured to electrically connect the second center of the second planar coil to the fourth center of the fourth planar coil; and
a fourth connection conductor that has the same layer as the third and fourth conductors and is configured to electrically connect the third end portion of the third planar coil and the fourth end portion of the fourth planar coil, wherein
the first and second end portions of the first and second planar coils are electrically connected to each other by an electrical path including the second, third, and fourth connection conductors and the first to fourth planar coils.

7. The planar coil array according to claim 6, wherein
each of the second, third, and fourth connection conductors and each of the third and fourth planar coils are formed in a multilayer structure according to a double-sided mounting technique for a printed board or a multilayer structure according to a multilayer wiring technique of forming an interlayer insulating layer and a multilayer wiring layer on a board.

8. A planar coil array comprising:
the plurality of planar coil arrays according to claim 1, wherein
the planar coil arrays extend parallel to each other along a predetermined direction, are stacked at intervals in a direction orthogonal to the predetermined direction, and the planar coil arrays are electrically connected to form one planar coil array.

9. A displacement sensor comprising:
the planar coil array according to claim 1; and
a detection unit configured to detect a change in an electrical characteristic of an electric signal, which is generated according to a displacement amount of a movable conductive object and transmitted via the planar coil array.

10. The displacement sensor according to claim 9, wherein
the planar coil array is disposed between a comb-tooth member and a comb-tooth member in a comb-tooth structure of the object.

11. The displacement sensor according to claim 9, wherein
the object is a component of a suspension, and the displacement sensor is a stroke sensor that measures a displacement amount of the suspension by detecting a frequency of an AC signal as the electric signal or a variation in an inductance, which changes according to a relative positional relationship between the component of the suspension and the planar coil array.
